(19) United States
(12) Patent Application Publication
(10) Pub. No.: US 2026/0271098 A1
(43) Pub. Date: Sep. 10, 2026

(54) SECONDARY CELL STATE CHANGE MESSAGING

(71) Applicant: QUALCOMM Incorporated, San Diego, CA (US)

(72) Inventors: Qian ZHANG, Basking Ridge, NJ (US); Mostafa KHOSHNEVISAN, San Diego, CA (US); Tao LUO, San Diego, CA (US); Jelena DAMNJANOVIC, Del Mar, CA (US); Junyi LI, Greentown, PA (US); Wooseok NAM, San Diego, CA (US); Navid ABEDINI, Basking Ridge, NJ (US); Xiaoxia ZHANG, San Diego, CA (US)

(21) Appl. No.: 19/446,965

(22) Filed: Jan. 13, 2026

Related U.S. Application Data
(60) Provisional application No. 63/768,637, filed on Mar. 7, 2025.

(51) Int. Cl. H04W 76/10; H04L 5/00

(52) U.S. Cl. CPC H04W 76/10; H04L 5/0048

(57) ABSTRACT

Various aspects of the present disclosure generally relate to wireless communication. A user equipment (UE) may start a deactivation timer to determine whether to deactivate a cell. When the deactivation timer expires, the UE may deactivate the cell, such as a secondary cell (SCell), which may reduce power consumption by the UE. However, using a timer may result in inefficiencies. Various aspects relate generally to cell state change, such as for SCell activation or deactivation. For example, a UE may detect an occurrence of an event and change a state of a cell. In some aspects, the UE may activate a cell, deactivate a cell, transition to or from a lightly-activated state for a cell, or perform another cell state change action in connection with an event.

### CROSS-REFERENCE TO RELATED APPLICATION

This Patent Application claims priority to U.S. Provisional Patent Application No. 63/768,637, filed on March 7, 2025, entitled “SECONDARY CELL STATE CHANGE MESSAGING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with secondary cell state change messaging.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some examples, a user equipment (UE) may implement different modes associated with different capabilities. For example, a UE may activate or deactivate a cell. A UE may deactivate a cell based on expiration of a cell deactivation timer, which may occur when there is no traffic on the cell for the UE within a configured period of time. The UE may reset the cell deactivation timer when scheduling activities occur, which may extend a period of time in which a cell is activated. By deactivating a cell, the UE may reduce a utilization of network resources or a utilization of UE power resources associated with maintaining a connection to network services via the cell.

### SUMMARY

Some aspects described herein relate to a method of wireless communication performed by a user equipment (UE). The method may include transmitting, to a network entity, a first message that indicates a request for an occurrence of a UE-initiated state change associated with a secondary cell (SCell) in accordance with an occurrence of an event. The method may include receiving, from the network entity and responsive to the request, a second message that indicates a state change associated with the SCell.

Some aspects described herein relate to a method of wireless communication performed by a network entity. The method may include receiving, from a UE, a first message that indicates a request for an occurrence of a UE-initiated state change associated with an SCell in accordance with an occurrence of an event. The method may include transmitting, from the network entity and responsive to the request, a second message that indicates a state change associated with the SCell.

Some aspects described herein relate to a UE. The UE may include a processing system. The processing system may include one or more processors and one or more code-storing memories coupled with the one or more processors. The processing system may be configured to cause the UE to transmit, to a network entity, a first message that indicates a request for an occurrence of a UE-initiated state change associated with an SCell in accordance with an occurrence of an event. The processing system may be configured to cause the UE to receive, from the network entity and responsive to the request, a second message that indicates a state change associated with the SCell.

Some aspects described herein relate to a network entity. The network entity may include a processing system. The processing system may include one or more processors and one or more code-storing memories coupled with the one or more processors. The processing system may be configured to cause the network entity to receive, from a UE, a first message that indicates a request for an occurrence of a UE-initiated state change associated with an SCell in accordance with an occurrence of an event. The processing system may be configured to cause the network entity to transmit, from the network entity and responsive to the request, a second message that indicates a state change associated with the SCell.

Some aspects described herein relate to a non-transitory computer-readable medium that stores a set of instructions for wireless communication by a UE. The set of instructions, when executed by one or more processors of the UE, may cause the UE to transmit, to a network entity, a first message that indicates a request for an occurrence of a UE-initiated state change associated with an SCell in accordance with an occurrence of an event. The set of instructions, when executed by one or more processors of the UE, may cause the UE to receive, from the network entity and responsive to the request, a second message that indicates a state change associated with the SCell.

Some aspects described herein relate to a non-transitory computer-readable medium that stores a set of instructions for wireless communication by a network entity. The set of instructions, when executed by one or more processors of the network entity, may cause the network entity to receive, from a UE, a first message that indicates a request for an occurrence of a UE-initiated state change associated with an SCell in accordance with an occurrence of an event. The set of instructions, when executed by one or more processors of the network entity, may cause the network entity to transmit, from the network entity and responsive to the request, a second message that indicates a state change associated with the SCell.

Some aspects described herein relate to an apparatus for wireless communication. The apparatus may include means for transmitting, to a network entity, a first message that indicates a request for an occurrence of an apparatus-initiated state change associated with an SCell in accordance with an occurrence of an event. The apparatus may include means for receiving, from the network entity and responsive to the request, a second message that indicates a state change associated with the SCell.

Some aspects described herein relate to an apparatus for wireless communication. The apparatus may include means for receiving, from a UE, a first message that indicates a request for an occurrence of a UE-initiated state change associated with an SCell in accordance with an occurrence of an event. The apparatus may include means for transmitting, from the network entity and responsive to the request, a second message that indicates a state change associated with the SCell.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network entity, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example associated with secondary cell (SCell) deactivation, in accordance with the present disclosure.

FIG. 4 is a diagram illustrating an example associated with SCell activation, in accordance with the present disclosure.

FIG. 5 is a diagram illustrating an example associated with an SCell state change for an SCell lightly-activated state, in accordance with the present disclosure.

FIG. 6 is a flowchart illustrating an example process performed, for example, at a user equipment (UE) or an apparatus of a UE that supports SCell state change messaging.

FIG. 7 is a flowchart illustrating an example process performed, for example, at a network entity or an apparatus of a network entity that supports SCell state change messaging.

FIG. 8 is a diagram of an example apparatus for wireless communication that supports SCell state change messaging.

FIG. 9 is a diagram of an example apparatus for wireless communication that supports SCell state change messaging.

### DETAILED DESCRIPTION

A user equipment (UE) may start a deactivation timer to determine whether to deactivate a cell. When the deactivation timer expires, the UE may deactivate the cell, such as a secondary cell (SCell), which may reduce power consumption by the UE. The UE may reset the deactivation timer when there is an occurrence of network traffic for the UE or a scheduling operation. However, using a timer may result in inefficiencies in cell deactivation. For example, when a relatively long timer is configured, but there is no traffic, the UE may keep a cell activated for a relatively long period of time before the timer expires, thereby resulting in excess utilization of power resources. In contrast, when a relatively short timer is configured, the UE may deactivate a cell as a result of a short period without network traffic, which may result in excess network signaling to reactivate the cell when there is network traffic for the UE. A network node may transmit scheduling messages, such as grants, to cause the UE to reset the deactivation timer and keep a cell activated, but transmitting scheduling messages to suppress a cell state change may unnecessarily use network resources. Further, if a UE misses downlink control information (DCI) providing a scheduling message, the UE may deactivate a cell incorrectly (without a network node having information that the UE has deactivated the cell), resulting in dropped communications. Further, a UE may keep a cell activated, as a result of a lack of timer expiration, even when the cell has a relatively poor radio condition, such as a relatively low reference signal received power, a relatively low signal quality, or a relatively high error rate, among other characteristics.

Various aspects relate generally to cell state change, such as for SCell activation or deactivation. Some aspects more specifically relate to an event-based cell state change, such as a UE detecting an occurrence of an event and changing a state of a cell or requesting a change to the state of the cell based on the occurrence of the event. In some aspects, the UE may activate a cell, deactivate a cell, transition to or from a lightly-activated state for a cell, or perform another cell state change action in connection with an event. In some aspects, the UE may transmit a message to trigger a UE-initiated state change. In some aspects, the UE may transmit a message to request a UE-initiated state change.

Particular aspects of the subject matter described in this disclosure can be implemented to realize one or more of the following potential advantages. In some examples, the described techniques can be used to reduce a latency associated with cell state change, thereby reducing power consumption associated with deactivating a cell or reducing communication delay associated with activating a cell, among other examples. In some examples, the described techniques can be used to reduce a likelihood of an incorrect cell state change relative to timer based cell state change and grant based suppression of a cell state change. In some examples, the described techniques can be used to reduce an amount of time that a cell with a relatively poor radio condition is used, thereby enabling a switch to a cell with a better radio condition and improving communication performance.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

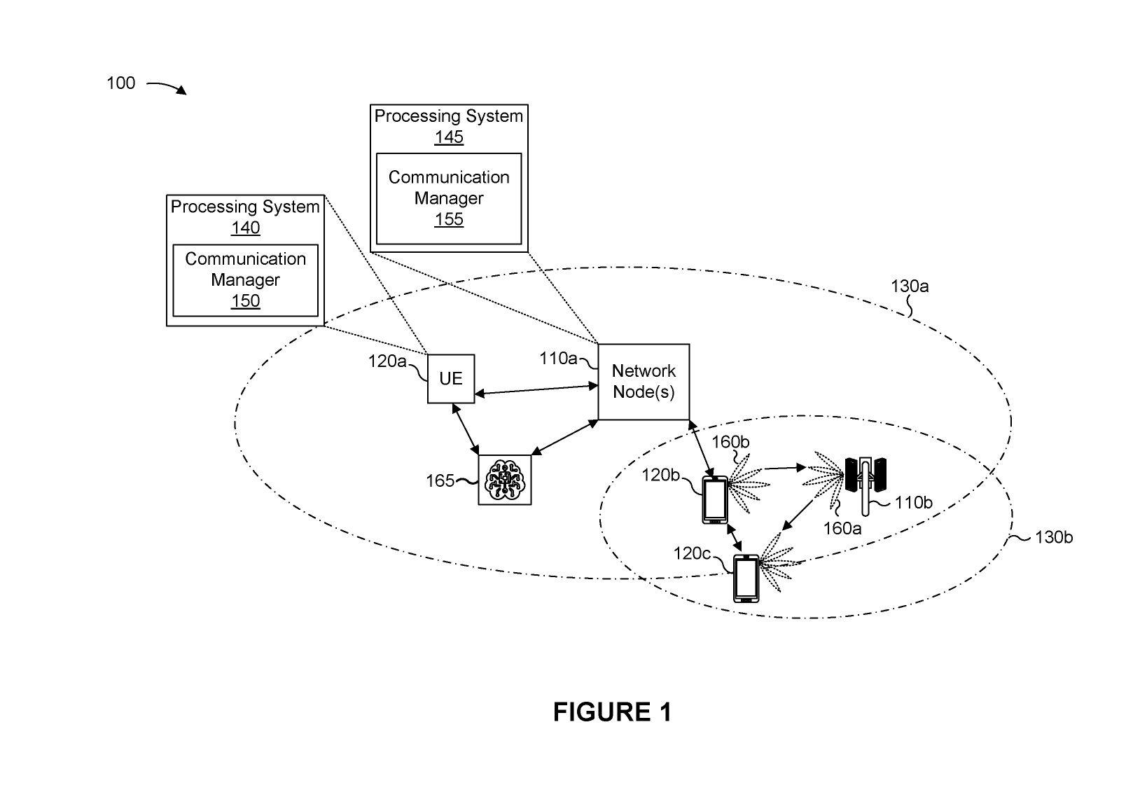

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs120 may be classified according to different categories in association with different complexities or different capabilities. UEs120 in a first category may be associated with relatively low complexity or cost such as NB-IoT devices or eMTC UEs. UEs120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs120 may have mid-tier complexity or capabilities (for example, capabilities between that of the UEs120 of the first category and the UEs120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally or alternatively, the AI/ML model(s) may enable AI/ML procedures (for example, RAN-triggered service establishment, configuration, inferencing using UE-side or network-side models, performance monitoring or management, or capability signaling, among other examples). Additionally or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may transmit, to a network entity, a first message that indicates a request for an occurrence of a UE-initiated state change associated with an SCell in accordance with an occurrence of an event; and receive, from the network entity and responsive to the request, a second message that indicates a state change associated with the SCell. Additionally or alternatively, the communication manager 150 may perform one or more other operations described herein.

In some aspects, the network entity (for example, a network node 110) may include a communication manager 155. As described in more detail elsewhere herein, the communication manager 155 may receive, from a UE, a first message that indicates a request for an occurrence of a UE-initiated state change associated with an SCell in accordance with an occurrence of an event; and transmit, from the network entity and responsive to the request, a second message that indicates a state change associated with the SCell. Additionally or alternatively, the communication manager 155 may perform one or more other operations described herein.

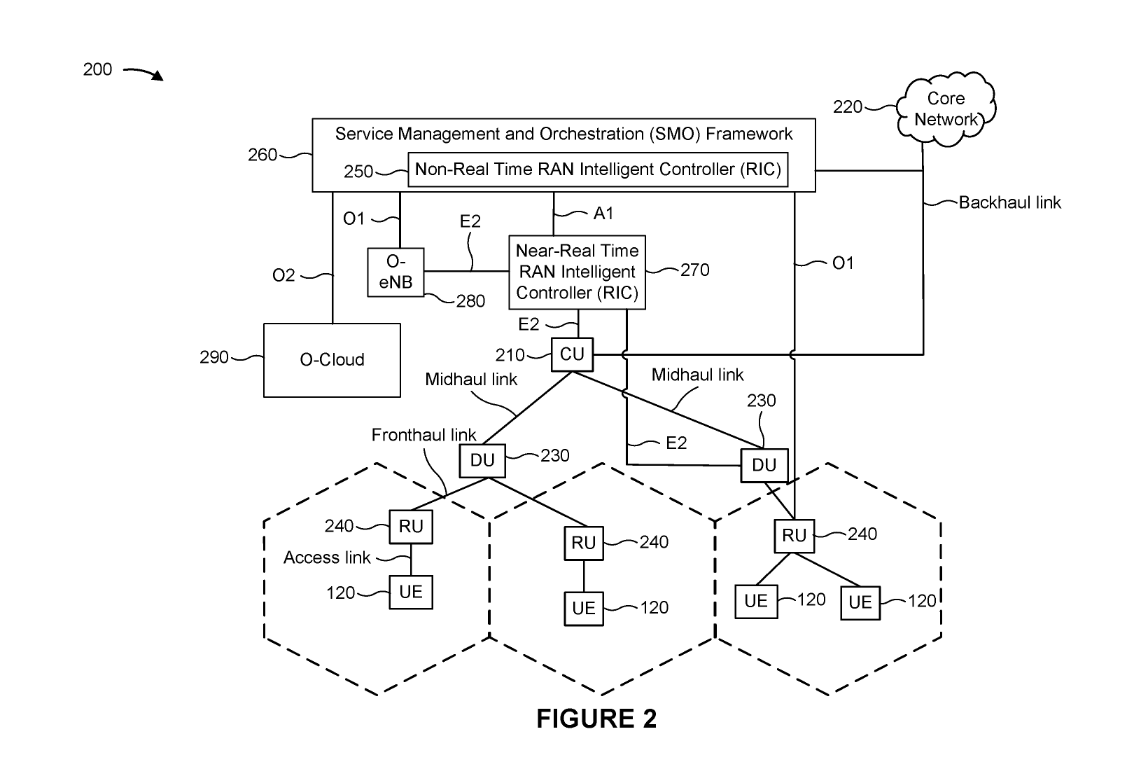

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs230 via respective midhaul links, such as via F1 interfaces. Each of the DUs230 may communicate with one or more RUs 240 via respective fronthaul links. Each of the RUs 240 may communicate with one or more UEs 120 via respective RF access links. In some deployments, a UE 120 may be simultaneously served by multiple RUs240.

Each of the components of the disaggregated network node architecture 200, including the CUs 210, the DUs 230, the RUs 240, the Near-RT RICs270, the Non-RT RICs250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

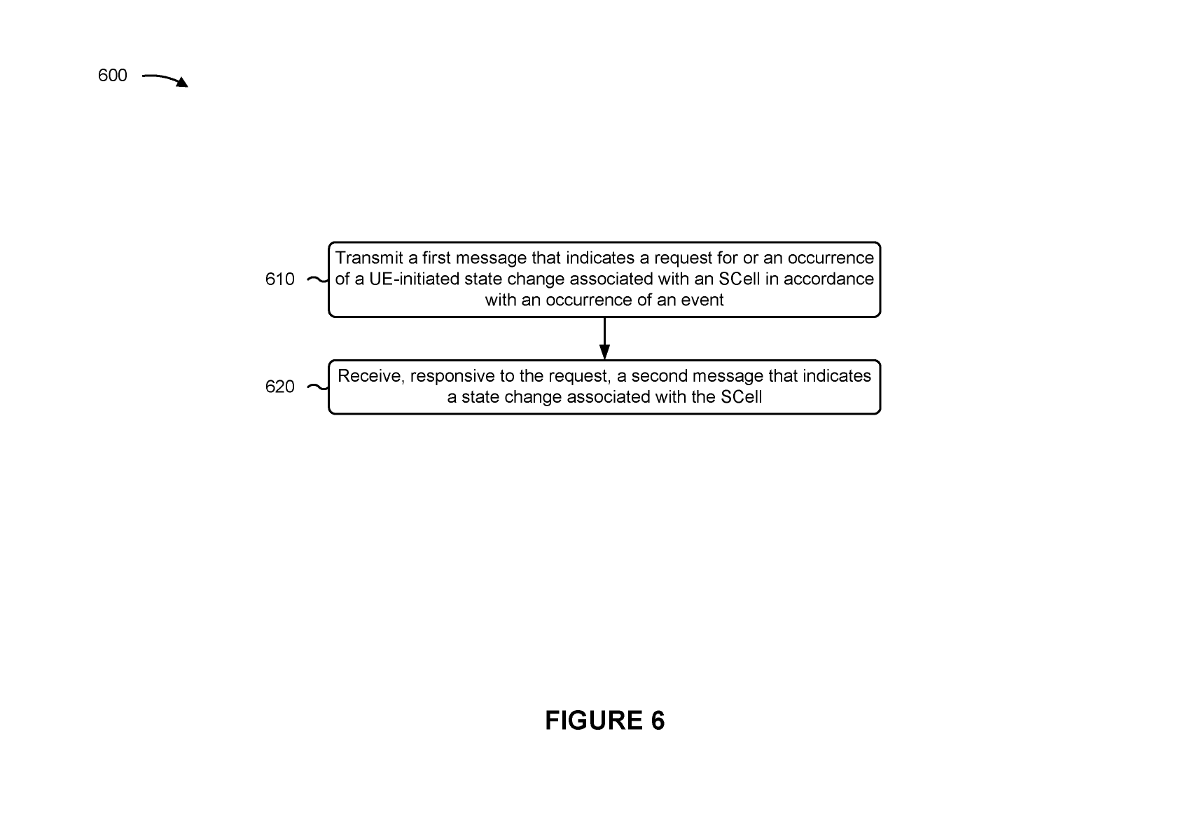

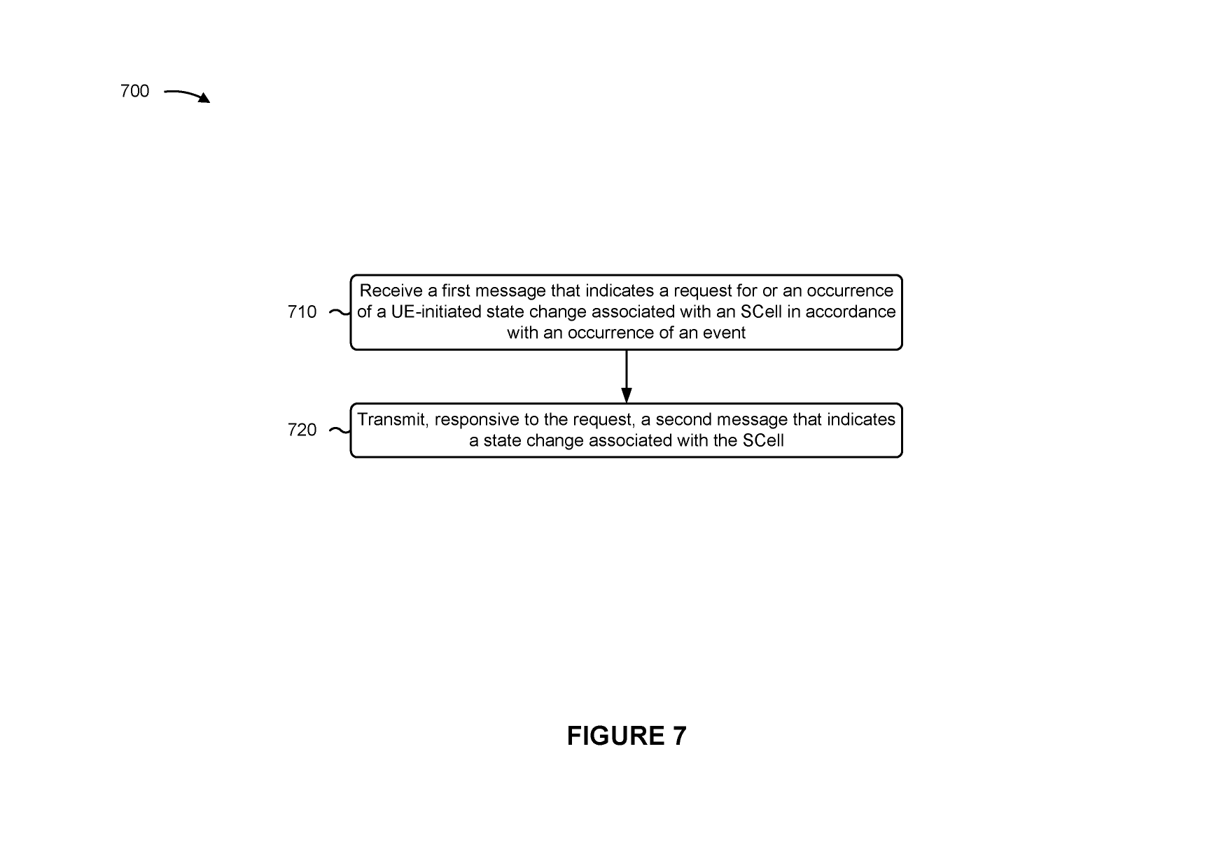

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with SCell state change messaging, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

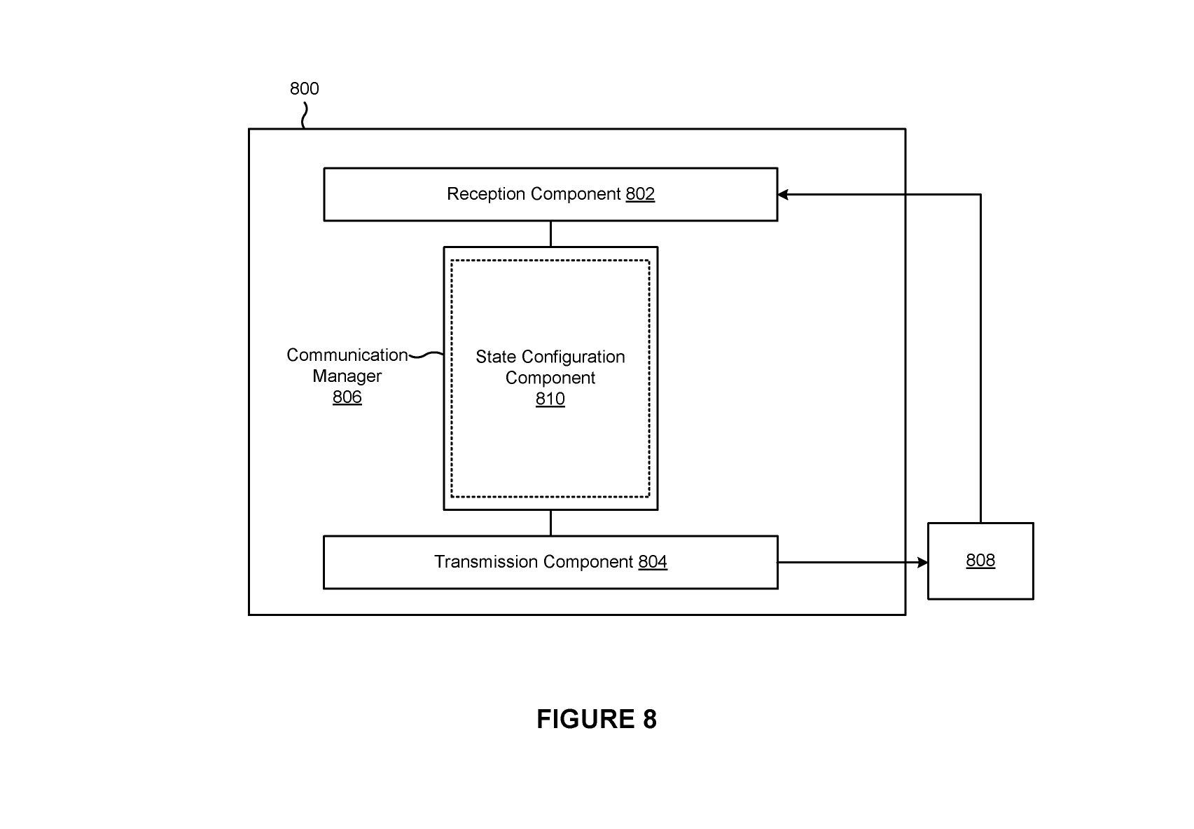

In some aspects, the UE 120 includes means for transmitting, to a network entity, a first message that indicates a request for an occurrence of a UE-initiated state change associated with a secondary cell (SCell) in accordance with an occurrence of an event; or means for receiving, from the network entity and responsive to the request, a second message that indicates a state change associated with the SCell. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

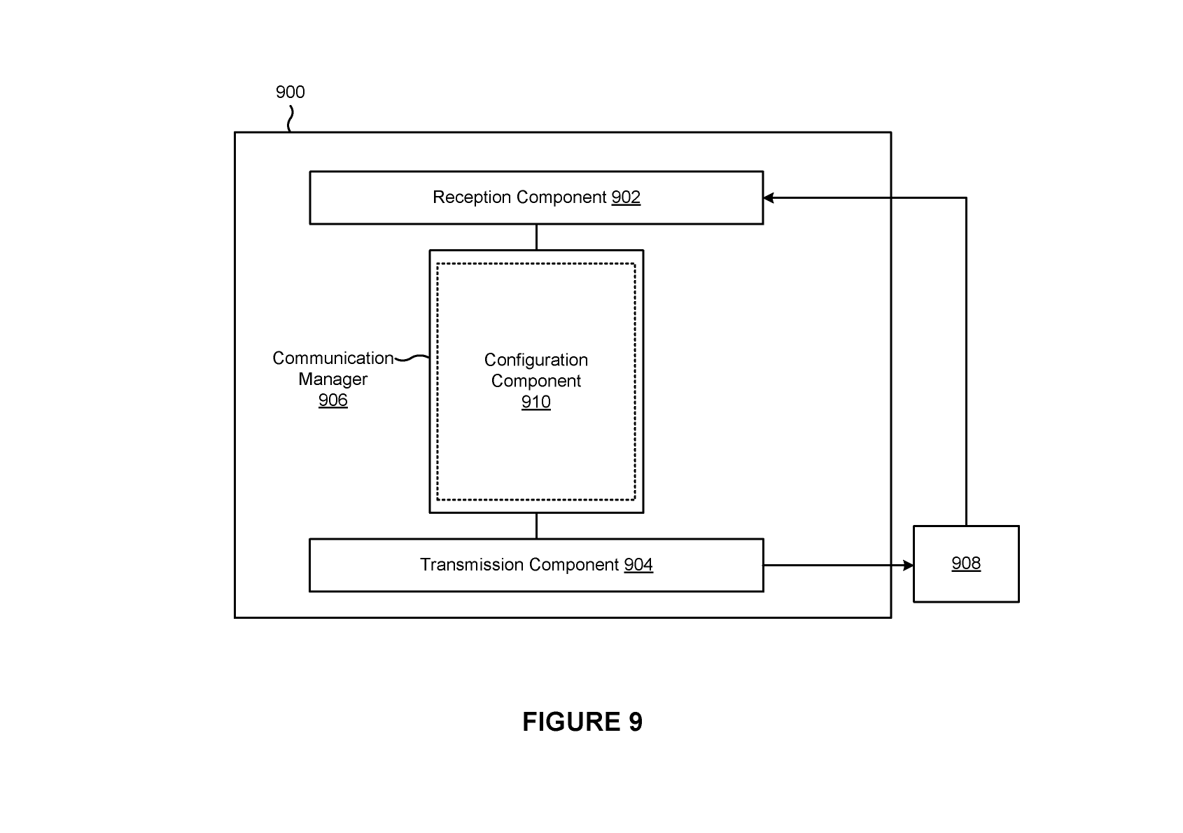

In some aspects, the network entity (for example, a network node 110) includes means for receiving, from a UE, a first message that indicates a request for an occurrence of a UE-initiated state change associated with an SCell in accordance with an occurrence of an event; or means for transmitting, from the network entity and responsive to the request, a second message that indicates a state change associated with the SCell. In some aspects, the means for the network entity to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

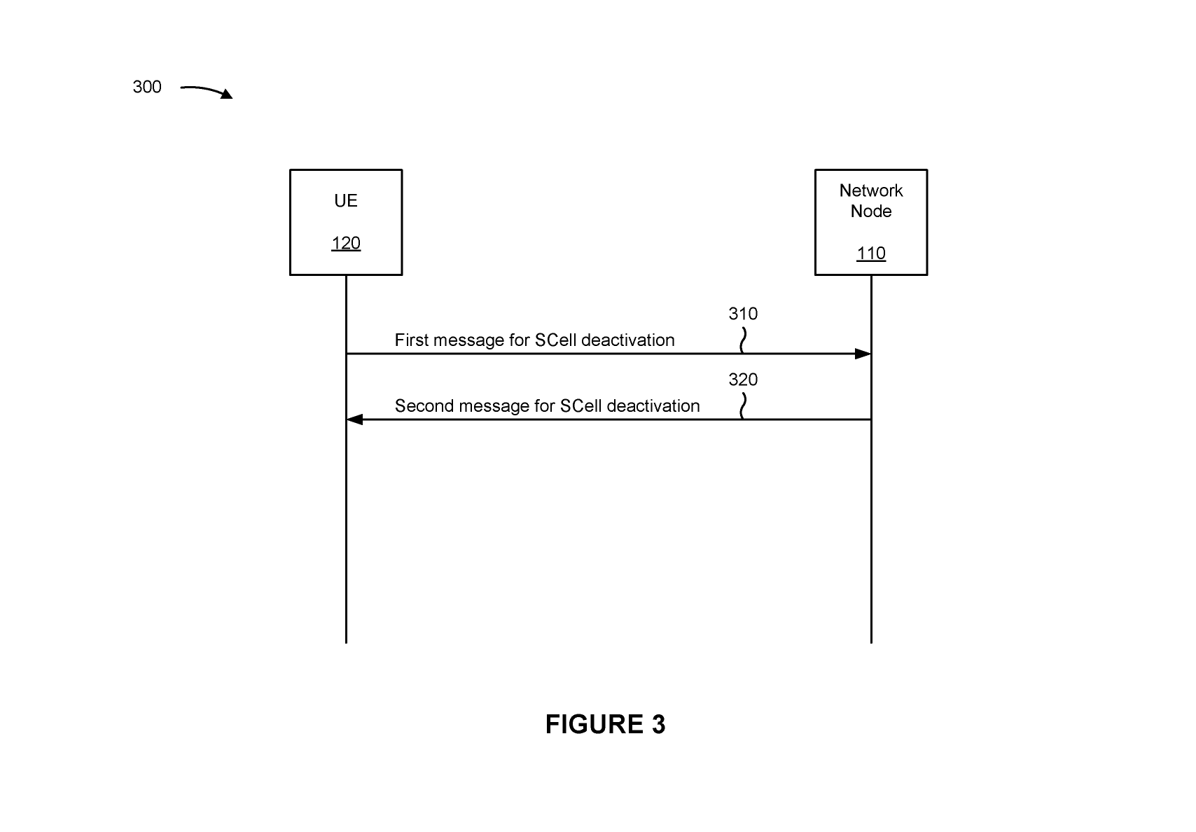

FIG. 3 is a diagram illustrating an example 300 associated with SCell deactivation, in accordance with the present disclosure. As shown in FIG. 3, example 300 includes communication between a network node 110 and a UE 120.

As further shown in FIG. 3, and in an operation 310, the UE 120 may transmit a first message for SCell deactivation. For example, the UE 120 may transmit a signal indicating SCell deactivation in accordance with an occurrence of an event. In some aspects, the UE 120 may transmit a signal indicating UE-initiated, event-based SCell deactivation using a configured type of signal. For example, the UE 120 may transmit a layer three (L3) report, such as radio resource control (RRC) signaling or UE assistance information (UAI) signaling. Additionally or alternatively, the UE 120 may transmit a layer two (L2) report, such as medium access control (MAC) control element (MAC-CE) signaling, in connection with an uplink transport block of a physical uplink shared channel (PUSCH) communication. Additionally or alternatively, the UE 120 may transmit a layer one (L1) report, such as uplink control information (UCI) signaling.

In some aspects, the UE 120 may transmit the signal to indicate an SCell removal (for example, rather than an SCell deactivation, as described in more detail herein). For example, in addition or alternatively to triggering deactivation of an SCell, the UE 120 may trigger or request that an SCell be removed from a list of RRC-configured SCells (which may not be activated yet). In this example, SCell removal occurs at the RRC layer (rather than the MAC layer, as for SCell deactivation).

In some aspects, the UE 120 may transmit the signal to indicate an SCell deactivation in connection with an enabling signal. For example, the network node 110 may transmit configuration information, such as via RRC signaling or MAC-CE signaling, associated with enabling or disabling UE-initiated SCell deactivation. In this example, the network node 110 may enable or disable UE-initiated SCell deactivation across a plurality of SCells or on a per-SCell basis, such that UE-initiated SCell deactivation is enabled for some SCells and disabled for other SCells. In some aspects, the UE 120 may transmit UE capability information identifying a UE capability and the network node 110 may configure, enable, or disable UE-initiated SCell deactivation in connection with the UE capability. For example, the UE 120 may indicate a processing capability and the network node 110 may enable UE-initiated SCell deactivation in connection with a first subset of events, as described herein, and disable SCell deactivation in connection with a second subset of events in accordance with the UE processing capability.

In some aspects, the UE 120 may transmit a request to deactivate the SCell. For example, the UE 120 may transmit a request message to a network node 110, but may not deactivate the SCell until the UE 120 receives a confirmation of the request via a response message transmitted by the network node 110. In this example, the network node 110 may transmit a legacy SCell deactivation MAC-CE or a request-response specific message indicating that the network node 110 is responding to the request for SCell deactivation in accordance with the occurrence of the event. In some aspects, a response from the network node 110, as described in more detail herein, may convey an acknowledgment (ACK) or a negative acknowledgment (NACK) indicating whether the UE 120 is to deactivate the SCell or not deactivate the SCell, respectively. Additionally or alternatively, the UE 120 may transmit the request message to the network node 110, but may not receive a response. In this example, when the UE 120 does not receive a confirmation or rejection of the request to deactivate the SCell within a configured time window, the UE 120 may follow a default behavior, such as keeping the SCell active or deactivating the SCell, among other examples. In some aspects, when the UE 120 does not receive the confirmation or rejection within the configured time window, the UE 120 may fall back to a legacy timer-based behavior, such as deactivating the SCell when a timer (sCellDeactivationTimer) expires. In some aspects, an amount of time of the configured window for receiving the response may be associated with a statically configured time value or a signaled time value. For example, the UE 120 may receive configuration information from the network node 110 indicating a time value for the configured time window. Additionally or alternatively, the UE 120 may transmit an indication that the SCell has already been deactivated or is to be deactivated (without requesting deactivation from the network node 110). For example, when the UE 120 detects an occurrence of an event, the UE 120 may trigger deactivation of an SCell and may transmit a first signal to the network node 110 to indicate that the SCell has been or is to be deactivated (without waiting for the network node 110 to approve the deactivation of the SCell).

In some aspects, the UE 120 may trigger the SCell deactivation in accordance with a detection of or an occurrence of an event. For example, the UE 120 may determine that a timer has expired, such as an sCellDeactivationTimer, and may trigger deactivation of an SCell as a result of the timer having expired, thereby avoiding misalignment between the UE 120 and the network node 110, which can occur as a result of missing (not successfully received) DCI messages. In some aspects, the UE 120 may trigger the SCell deactivation in accordance with an uplink buffer status, such as an actual uplink buffer status or a predicted uplink buffer status. For example, when the UE 120 determines that an uplink buffer status (such as an actual or predicted uplink buffer status) is associated with no uplink data or less than a threshold amount of uplink data during a configured time window, the UE 120 may transmit an indication for an SCell deactivation. In this example, the threshold amount of uplink data or a length of the configured time window may be associated with a UE configuration or a network node 110 signaled configuration.

In some aspects, the UE 120 may trigger the SCell deactivation in accordance with a downlink traffic amount, such as a predicted downlink traffic amount. For example, the UE 120 may receive an indication of a prediction of downlink traffic from an application layer entity and may trigger SCell deactivation when there is no downlink traffic or less than a threshold amount of downlink traffic (such as predicted downlink traffic) during a configured time window. In this example, the threshold amount of downlink traffic or a length of the configured time window may be associated with a UE configuration or a network node 110 signaled configuration.

In some aspects, the UE 120 may trigger SCell deactivation in accordance with a channel quality metric, such as a channel quality measurement or a channel quality prediction. For example, when the UE 120 determines that a (predicted or actual) channel quality, such as a layer 1 (L1) reference signal received power (RSRP) (L1-RSRP), an L1 SINR (L1-SINR), or a channel quality indicator (CQI), is less than a threshold channel quality for a configured time window, the UE 120 may trigger SCell deactivation. The threshold channel quality or the configured time window may be associated with a UE configuration or a network node 110 signaled configuration. In some aspects, the network node 110 may signal a channel quality metric, a downlink reference signal (for example, a synchronization signal block (SSB) or a channel state information (CSI) reference signal (CSI-RS)), or a configuration that the UE 120 can use for evaluating channel quality and determining whether to trigger SCell deactivation.

In some aspects, the UE 120 may trigger SCell deactivation in accordance with a set of parameters, such as a monitoring window, an activity type, or a threshold. For example, the UE 120 may trigger SCell deactivation when a configured activity type occurs within a monitoring window and satisfies a threshold. In this example, the monitoring window may include a time period in which the UE 120 monitors for one or more activities on the SCell and may be a network node 110 configured monitoring window associated with a periodic pattern. In some aspects, the activity type may include a detection of a DCI format scheduling downlink or uplink data, a physical downlink shared channel (PDSCH) reception, a PUSCH transmission, a hybrid automatic repeat request (HARQ) feedback transmission for a PDSCH reception, a detection of a DCI format associated with triggering aperiodic CSI measurement or reporting, a transmission of an aperiodic CSI report, a detection of a DCI format triggering aperiodic sounding reference signal (SRS) transmission, or a transmission of an aperiodic SRS. In some aspects, the network node 110 may transmit configuration information to configure a set of activity types or indicate a selection of an activity type for which the UE 120 is to monitor. In some aspects, the threshold may include a time threshold, such as a timer, since a last detected activity. Additionally or alternatively, the threshold may include an activity count threshold during one or more activity windows, a threshold value for an average inter-arrival time of one or more activities during one or more activity windows, a data rate threshold for a downlink or uplink data rate of scheduled communications during one or more activity windows, or a combination thereof. In some aspects, the network node 110 may configure and signal parameters relating to a threshold, such as on a per activity type basis.

In some aspects, the UE 120 may trigger SCell deactivation in accordance with a power headroom or energy headroom of the UE 120 for uplink transmissions. For example, the UE 120 may determine that an available transmit power or energy for a configured time window is less than a threshold amount, which may trigger the UE 120 to signal for SCell deactivation. In this example, the configured time window or the threshold amount may be based on a UE configuration or a network node 110 signaled configuration.

In some aspects, the UE 120 may trigger SCell deactivation in accordance with a grant, such as a grant prediction. For example, the UE 120 may predict (for example, using artificial intelligence (AI) or machine learning (ML) (AI/ML)) that a quantity of downlink or uplink grants or a data rate thereof is less than a threshold. In this example, the UE 120 may determine a prediction using one or more inputs, such as using a scheduler behavior history or a traffic prediction or history as an input. In some aspects, when the UE 120 predicts that a grant characteristic, such as a quantity of grants during a configured time window, is less than a threshold value, the UE 120 may trigger SCell deactivation.

In some aspects, the UE 120 may trigger SCell deactivation in accordance with an occurrence of a combination of a plurality of events. For example, the UE 120 may trigger SCell deactivation when a data rate is less than a (predicted) data rate threshold and a power headroom is less than a power headroom threshold. In some aspects, the network node 110 may configure one or more events or one or more parameters thereof for the UE 120. For example, the network node 110 may transmit configuration information via RRC signaling, DCI signaling, MAC-CE signaling, or system information signaling, among other examples. In some aspects, one or more events may be configured for the UE 120 in connection with one or more SCells. For example, the UE 120 may be configured with a first set of parameters for an event on a first SCell and a second set of parameters for an event on a second SCell. Additionally or alternatively, an event may be configured across SCells. For example, a threshold value relating to downlink traffic may be configured for downlink traffic across a plurality of cells. Additionally or alternatively, an uplink power threshold may be configured across a plurality of component carriers (CCs) on which the UE 120 can transmit. Additionally or alternatively, the UE 120 may be configured to determine how many CCs or cells, and which CCs or cells, to deactivate in connection with an occurrence of an event.

In some aspects, the UE 120 may transmit the first signal, for SCell deactivation, in connection with an SCell activation process. For example, when the UE 120 receives an SCell activation command from the network node 110, but has not yet activated the SCell, the UE 120 may transmit the first signal to trigger SCell deactivation to override the SCell activation command (or to request that the network node 110 override the SCell activation command). For example, as a result of an activation latency, the UE 120 may determine that, by the time an SCell is activated and ready for data transfer, uplink or downlink traffic will have already been communicated (for example, using a primary cell (PCell), so the UE 120 may override (or request an override of) activation of the SCell. Additionally or alternatively, when the UE 120 determines that a cell quality of an SCell, that is to be activated, is less than a threshold cell quality metric, the UE 120 may override (or request override of) activation of the SCell.

In some aspects, the UE 120 may include one or more parameters in the first signal for SCell deactivation. For example, the UE 120 may include, in the first signal for SCell deactivation, an indication of a set of SCells for which deactivation is occurring or is requested. Additionally or alternatively, the UE 120 may include an indicator of a quantity of SCells for which deactivation is occurring or is requested. Additionally or alternatively, the UE 120 may include an indication of a trigger for SCell deactivation, such as an indication of an event that caused the UE 120 to trigger deactivation. Additionally or alternatively, the UE 120 may include an indication of a time at which the SCell is to be deactivated. For example, when the UE 120 predicts a level of traffic or a channel quality at a future time, the UE 120 may indicate the future time so that the SCell is deactivated when the traffic level or channel quality is predicted to be less than a threshold (which may not result in an immediate SCell deactivation).

As further shown in FIG. 3, and in an operation 320, the UE 120 may receive a second message for SCell deactivation. For example, the UE 120 may receive a second message indicating a confirmation of the SCell deactivation or a rejection of the SCell deactivation when the UE 120 transmits a request for SCell deactivation. Additionally or alternatively, the UE 120 may receive, from the network node 110, an acknowledgment message indicating that the network node 110 has received an indication that the UE 120 has deactivated an SCell. Additionally or alternatively, the UE 120 may receive, from the network node 110, a signal on a different SCell or on a PCell, in accordance with the UE 120 having deactivated an SCell.

As indicated above, FIG. 3 is provided as an example. Other examples may differ from what is described with respect to FIG. 3.

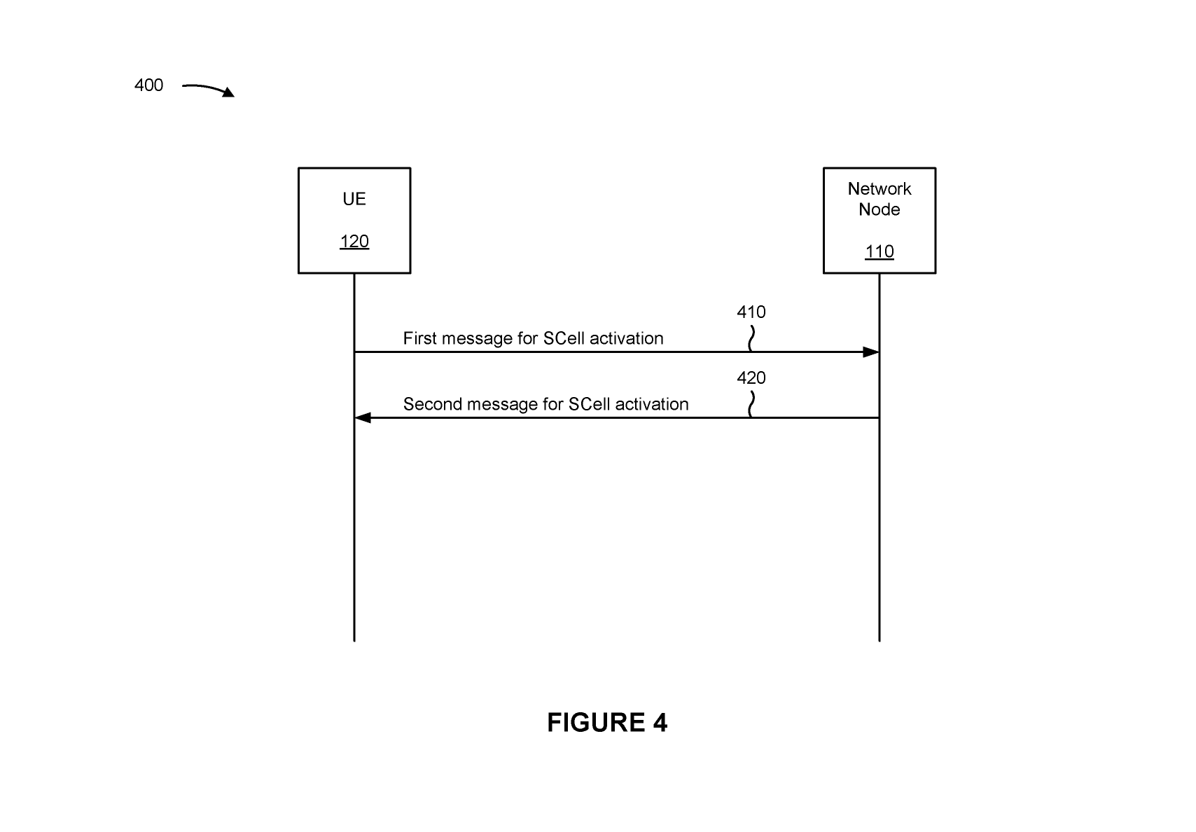

FIG. 4 is a diagram illustrating an example 400 associated with SCell activation, in accordance with the present disclosure. As shown in FIG. 4, example 400 includes communication between a network node 110 and a UE 120.

As further shown in FIG. 4, and in an operation 410, the UE 120 may transmit a first message for SCell activation. For example, the UE 120 may transmit a signal indicating SCell activation in accordance with an occurrence of an event. In some aspects, the UE 120 may transmit a signal indicating UE-initiated, event-based SCell activation using a configured type of signal. For example, the UE 120 may transmit an L3 report, such as RRC signaling or UAI signaling. Additionally or alternatively, the UE 120 may transmit an L2 report, such as MAC-CE signaling, in connection with an uplink transport block of a PUSCH communication. Additionally or alternatively, the UE 120 may transmit an L1 report, such as UCI signaling.

In some aspects, the UE 120 may transmit the signal to indicate an SCell addition (for example, rather than an SCell activation, as described in more detail herein). For example, in addition or alternatively to triggering activation of an SCell, the UE 120 may trigger or request that an SCell be added to a list of RRC-configured SCells (which may not be activated yet). In this example, SCell addition occurs at the RRC layer (rather than the MAC layer, as for SCell activation). In some aspects, the network node 110 may query the UE 120 regarding whether an SCell can be activated. For example, the network node 110 may request information regarding whether an SCell can be activated, or configuring one or more events for determining whether to activate an SCell. In this example, the UE 120 may transmit the signal to indicate an SCell activation as a response to receiving the query from the network node 110.

In some aspects, the UE 120 may transmit the signal to indicate an SCell activation in connection with an enabling signal. For example, the network node 110 may transmit configuration information, such as via RRC signaling or MAC-CE signaling, associated with enabling or disabling UE-initiated SCell activation. In this example, the network node 110 may enable or disable UE-initiated SCell activation across a plurality of SCells or on a per-SCell basis, such that UE-initiated SCell activation is enabled for some SCells and disabled for other SCells. In some aspects, the UE 120 may transmit UE capability information identifying a UE capability and the network node 110 may configure, enable, or disable UE-initiated SCell activation in connection with the UE capability. For example, the UE 120 may indicate a processing capability and the network node 110 may enable UE-initiated SCell activation in connection with a first subset of events, as described herein, and disable SCell activation in connection with a second subset of events in accordance with the UE processing capability.

In some aspects, the UE 120 may transmit a request to activate the SCell. For example, the UE 120 may transmit a request message to a network node 110, but may not activate the SCell until the UE 120 receives a confirmation of the request via a response message transmitted by the network node 110. In this example, the network node 110 may transmit a legacy SCell activation MAC-CE or a request-response specific message indicating that the network node 110 is responding to the request for SCell activation in accordance with the occurrence of the event. In some aspects, a response from the network node 110, as described in more detail herein, may convey an ACK or a NACK indicating whether the UE 120 is to activate the SCell or not activate the SCell, respectively. Additionally or alternatively, the UE 120 may transmit the request message to the network node 110, but may not receive a response. In this example, when the UE 120 does not receive a confirmation or rejection of the request to activate the SCell within a configured time window, the UE 120 may follow a default behavior, such as keeping the SCell deactivated or activating the SCell, among other examples.

In some aspects, an amount of time of the configured window for receiving the response may be associated with a statically configured time value or a signaled time value. For example, the UE 120 may receive configuration information from the network node 110 indicating a time value for the configured time window. Additionally or alternatively, the UE 120 may transmit an indication that the SCell has already been activated or is to be activated (without requesting activation from the network node 110). For example, when the UE 120 detects an occurrence of an event, the UE 120 may trigger activation of an SCell and may transmit a first signal to the network node 110 to indicate that the SCell has been or is to be activated (without waiting for the network node 110 to approve the activation of the SCell).

In some aspects, the UE 120 may trigger the SCell deactivation in accordance with a detection of or an occurrence of an event. For example, the UE 120 may trigger the SCell activation in accordance with an uplink buffer status, such as an actual uplink buffer status or a predicted uplink buffer status. For example, when the UE 120 determines that an uplink buffer status (such as an actual or predicted uplink buffer status) is associated with more than a threshold amount of uplink data during a configured time window, the UE 120 may transmit an indication for an SCell activation. In this example, the threshold amount of uplink data or a length of the configured time window may be associated with a UE configuration or a network node 110 signaled configuration.

In some aspects, the UE 120 may trigger the SCell activation in accordance with a downlink traffic amount, such as a predicted downlink traffic amount. For example, the UE 120 may receive an indication of a prediction of downlink traffic from an application layer entity and may trigger SCell activation when there is more than a threshold amount of downlink traffic (such as predicted downlink traffic) during a configured time window. In this example, the threshold amount of downlink traffic or a length of the configured time window may be associated with a UE configuration or a network node 110 signaled configuration.

In some aspects, the UE 120 may trigger SCell deactivation in accordance with a channel quality metric, such as a channel quality measurement or a channel quality prediction. For example, when the UE 120 determines that a (predicted or actual) channel quality, such as an L1-RSRP, an L1 reference signal received quality (RSRQ) (L1-RSRQ), or a CQI, is greater than a threshold channel quality for a configured time window, the UE 120 may trigger SCell activation. The threshold channel quality or the configured time window may be associated with a UE configuration or a network node 110 signaled configuration. In some aspects, the network node 110 may signal a channel quality metric, a downlink reference signal (for example, an SSB or a CSI-RS), or a configuration that the UE 120 can use for evaluating channel quality and determining whether to trigger SCell deactivation. In some aspects, the network node 110 may configure one or more measurements in connection with one or more measurement gaps. For example, the network node 110 may configure L3 radio resource management (RRM) measurements in connection with configured measurement gaps, as the SCell is not yet activated. Although some aspects are described herein in terms of a particular set of event types for activation or deactivation, other event types may be used, and event types described in terms of one of activation or deactivation may be applicable to the other of activation or deactivation (or transition to a lightly-activated state as described herein).

In some aspects, the UE 120 may trigger SCell activation in accordance with an occurrence of a combination of a plurality of events. For example, the UE 120 may trigger SCell activation when a channel quality metric is greater than a channel quality metric threshold and when new data for communication is greater than a data threshold. In some aspects, the network node 110 may configure one or more events or one or more parameters thereof for the UE 120. For example, the network node 110 may transmit configuration information via RRC signaling, DCI signaling, MAC-CE signaling, or system information signaling, among other examples. In some aspects, one or more events may be configured for the UE 120 in connection with one or more SCells. For example, the UE 120 may be configured with a first set of parameters for an event on a first SCell and a second set of parameters for an event on a second SCell. Additionally or alternatively, an event may be configured across SCells. For example, a threshold value relating to downlink traffic may be configured for downlink traffic across a plurality of cells. Additionally or alternatively, the UE 120 may be configured to determine how many CCs or cells, and which CCs or cells, to activate in connection with an occurrence of an event.

In some aspects, the UE 120 may include one or more parameters in the first signal for SCell activation. For example, the UE 120 may include, in the first signal for SCell activation, an indication of a set of SCells for which activation is occurring or is requested. Additionally or alternatively, the UE 120 may include an indicator of a quantity of SCells for which activation is occurring or is requested. Additionally or alternatively, the UE 120 may include an indication of a trigger for SCell activation, such as an indication of an event that caused the UE 120 to trigger activation. Additionally or alternatively, the UE 120 may include an indication of a time at which the SCell is to be activated. For example, when the UE 120 predicts a level of traffic or a channel quality at a future time, the UE 120 may indicate the future time so that the SCell is activated when the traffic level or channel quality is predicted to be greater than a threshold (which may not result in an immediate SCell activation).

As further shown in FIG. 4, and in an operation 420, the UE 120 may receive a second message for SCell activation. For example, the UE 120 may receive a second message indicating a confirmation of the SCell activation or a rejection of the SCell activation when the UE 120 transmits a request for SCell activation. Additionally or alternatively, the UE 120 may receive, from the network node 110, an acknowledgment message indicating that the network node 110 has received an indication that the UE 120 has activated an SCell. Additionally or alternatively, the UE 120 may receive, from the network node 110, a signal on a different SCell or on a PCell, in accordance with the UE 120 having activated an SCell.

As indicated above, FIG. 4 is provided as an example. Other examples may differ from what is described with respect to FIG. 4.

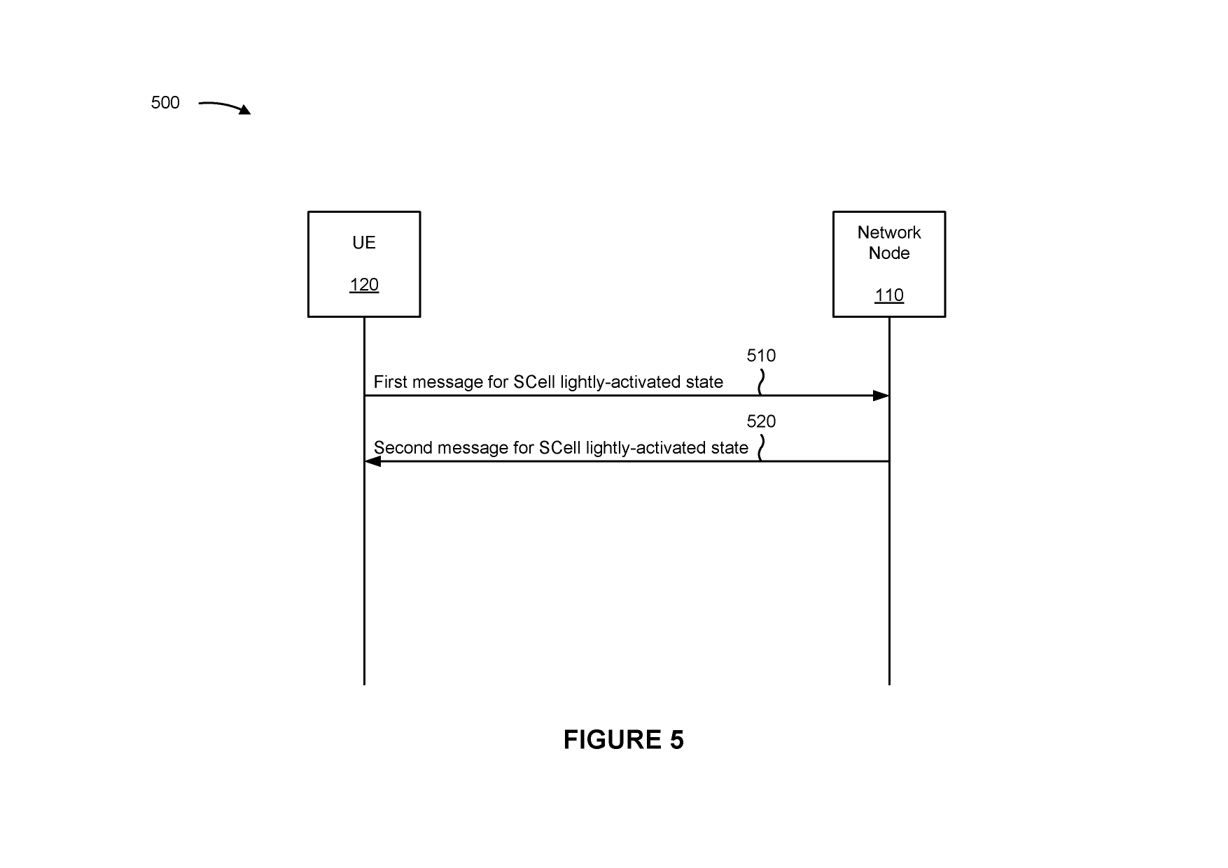

FIG. 5 is a diagram illustrating an example 500 associated with an SCell state change for an SCell lightly-activated state, in accordance with the present disclosure. As shown in FIG. 5, example 500 includes communication between a network node 110 and a UE 120.

As further shown in FIG. 5, and in an operation 510, the UE 120 may transmit, to the network node 110, a first signal associated with a state change to or from a lightly-activated state for an SCell. For example, the UE 120 may transmit a first signal associated with an event-based transition from a lightly-activated state to a deactivated state. Additionally or alternatively, the UE 120 may transmit a first signal associated with an event based transition from the lightly-activated state to an activated state. Additionally or alternatively, the UE 120 may transmit a first signal associated with an event-based transition from an activated state to a lightly-activated state. Additionally or alternatively, the UE 120 may transmit a first signal associated with a network-triggered transition from an activated state to a lightly-activated state, from a lightly-activated state to an activated state, or from a lightly-activated state to a deactivated state.

In some aspects, the UE 120 may transition between states in connection with a network-triggered message. For example, the UE 120 may receive a MAC-CE or DCI that is dedicated for a transition to or from a lightly-activated state. Additionally or alternatively, the UE 120 may transition to or from a lightly-activated state based on an occurrence of an event. For example, for down-transitions, such as a transition to a lightly-activated state (from an activated state) or to a deactivated state (from a lightly-activated state), the UE 120 may detect an event, such as a time expiration event, a buffer status event, a traffic event, a channel quality metric event, an activity type event, a power headroom or energy headroom event, or a grant prediction event, as described above in more detail with reference to FIG. 3. Additionally or alternatively, for up-transitions, such as a transition from a deactivated state to a lightly-activated state or from a lightly-activated state to an activated state, the UE 120 may detect an event such as a buffer status event, a traffic event, or a channel quality metric event, or an activity type event, as described in more detail with reference to FIG. 4.

In some aspects, (for down-transitions or up-transitions), the UE 120 may receive a signal with configuration information for configuring a parameter of an event. For example, the UE 120 may be configured with a first monitoring window, activity type, or threshold for detecting an event for an SCell transition from activated to deactivated and a second monitoring window, activity type, or threshold for detecting an event for an SCell transition from activated to lightly-activated. Additionally or alternatively, the network node 110 may configure a different one or more events or a different one or more parameters for each applicable event for transitions from activated states to lightly-activated states relative to transitions from lightly-activated states to deactivated states. Additionally or alternatively, a transition time for transitioning to or from a lightly activated state may differ from a transition time for transitioning to or from an activated state or a deactivated state. Additionally or alternatively, a transition time for transiting to a lightly-activated state may differ from a transition time for transitioning from a lightly-activated state in connection with a UE configuration or a network node signaled configuration.

In some aspects, the lightly-activated state is associated with a configuration of the UE 120. For example, in a first configuration, the UE 120 may, in a lightly-activated state, stop monitoring for a physical downlink control channel (PDCCH) on or for an SCell. Additionally or alternatively, the UE 120 may stop monitoring for physical downlink shared channel (PDSCH) reception on the SCell. Additionally or alternatively, the UE 120 may stop transmitting PUSCH, PUCCH, or SRS communications on the SCell. However, in the first configuration, the UE 120 may continue performing CSI measurements and reporting, such as periodic or semi-persistent CSI-RS measurements or reporting (but not aperiodic CSI-RS measurements and reporting). Additionally or alternatively, the UE 120 may continue performing beam management operations, such as performing L1-RSRP measurements or L1-SINR measurements and associated reporting, time and frequency tracking operations, or automatic gain control (AGC) operations.

Additionally or alternatively, in a second configuration, the UE 120 may, in a lightly-activated state, use a different value for a deactivation timer than is used for an activated state. For example, the UE 120 may use a first value for sCellDeactivationTimer when operating in an activated SCell state and a second, reduced value for sCellDeactivationTimer when operating in a lightly-activated state. By shortening the deactivation timer length for a lightly-activated state, the UE 120 may reduce an amount of time to transition to a deactivated state when no activity is detected, relative to when in an activated state. In some aspects, the UE 120 may receive configuration information indicating a value for a deactivation timer for the lightly-activated state via RRC or MAC-CE signaling, among other examples.

Additionally or alternatively, in a third configuration, the UE 120 may, in a lightly-activated state, be configured with a low duty cycle operation in accordance with a periodic on-off pattern. The UE 120 may receive configuration information, from the network node 110, configuring the periodic on-off pattern via RRC signaling or MAC-CE signaling, among other examples. When operating with the periodic on-off pattern, a first subset of operations may be enabled during an on time or off time and a second subset of operations may be disabled during an on time or off time. For example, during an off period, the UE 120 may forgo monitoring for PDCCH communications, transmitting PUSCH or PUCCH communications, or receiving CSI-RS transmissions, among other examples. In some aspects, the UE 120 may receive configuration information indicating which operations are disabled or enabled during on times or off times. In some aspects, the low duty cycle operation in accordance with the periodic on-off pattern may be configured on a per individual SCell basis and may be event based or triggered via a dynamic indication.

Additionally or alternatively, in a fourth configuration, the UE 120 may, in a lightly-activated state, perform low-power (LP) wake-up signal (WUS) associated operations. For example, in the lightly-activated state, the UE 120 may monitor for PDCCH or sequence-based downlink control to enable LP-WUS reception using a low-power wake-up radio (LP-WUR). In this example, the UE 120 may turn off a main radio on an SCell, thereby forgoing other communications for which the main radio is used. In some aspects, when using the LP-WUR (rather than the main radio), the UE 120 may perform RSRP or CSI measurements or reporting, thereby avoiding a long delay associated with moving to an activated state, but may forgo data reception or transmission (for example, of a PDSCH or PUSCH).

Based on receiving an LP-WUS in the lightly-activated state, which indicates a transition to an activated or deactivated state, the UE 120 may transmit an ACK message, such as on a PUCCH or PUSCH, in a same SCell on which the LP-WUS was received using an LP transmitter or on another CC using a main radio. After transmitting the ACK message, the UE 120 may transition to an activated or deactivated state. An amount of time or quantity of symbols after the ACK message that the UE 120 transitions to the activated or deactivated state may be associated with a UE capability, a configuration, or a type of state change. For example, the UE 120 may transition to an activated state a first quantity of symbols after transmission of an ACK, and may transition to a deactivated state a second quantity of symbols after transmission of an ACK.

In some aspects, the UE 120 may receive configuration information associated with enabling or disabling use of a lightly-activated state. For example, the network node 110 may transmit configuration information via RRC signaling or MAC-CE signaling enabling or disabling use of the lightly-activated state for a plurality of SCells or for a subset of SCells. Additionally or alternatively, the UE 120 may receive configuration information associated with configuring a type of lightly-activated state, such as the first through fourth configurations described above, a combination thereof, or another type of lightly-activated state configuration. Additionally or alternatively, the UE 120 may receive configuration information configuring an event based transition. In some aspects, the UE 120 may transmit a capability indicator identifying whether the UE 120 supports use of the lightly-activated state or one or more parameters thereof, such as a type or event for the lightly-activated state. The network node 110 may transmit configuration information as a response to the capability indicator to configure one or more lightly-activated state types or event transitions for one or more SCells.

As further shown in FIG. 5, and in an operation 520, the UE 120 may receive a second message for SCell lightly-activated state transition. For example, the UE 120 may receive a second message indicating a confirmation of the SCell transition to or from a lightly-activated state or a rejection of the SCell transition to or from a lightly activated state when the UE 120 transmits a request for SCell state change. Additionally or alternatively, the UE 120 may receive, from the network node 110, an acknowledgment message indicating that the network node 110 has received an indication that the UE 120 has transitioned to or from a lightly-activated state.

As indicated above, FIG. 5 is provided as an example. Other examples may differ from what is described with respect to FIG. 5.

FIG. 6 is a flowchart illustrating an example process 600 performed, for example, at a UE or an apparatus of a UE that supports SCell state change messaging. Example process 600 is an example where the apparatus or the UE (for example, UE 120) performs operations associated with SCell state change messaging.

As shown in FIG. 6, in some aspects, process 600 may include transmitting a first message that indicates a request for an occurrence of a UE-initiated state change associated with an SCell in accordance with an occurrence of an event (block 610). For example, the UE (such as by using transmission component 804, depicted in FIG. 8) may wirelessly transmit, to a network entity, a first message that indicates a request for an occurrence of a UE-initiated state change associated with an SCell in accordance with an occurrence of an event, as described above.

As further shown in FIG. 6, in some aspects, process 600 may include receiving, from the network entity and responsive to the request, a second message that indicates a state change associated with the SCell (block 620). For example, the UE (such as by using reception component 802, depicted in FIG. 8) may wirelessly receive, from the network entity and responsive to the request, a second message that indicates a state change associated with the SCell, as described above.

Process 600 may include additional aspects, such as any single aspect or any combination of aspects described below or in connection with one or more other processes described elsewhere herein.

In a first additional aspect, the first message includes an SCell deactivation message or an SCell removal message.

In a second additional aspect, alone or in combination with the first aspect, the first message includes the request for the state change, and the second message includes a confirmation of the request for the state change.

In a third additional aspect, alone or in combination with one or more of the first and second aspects, the confirmation is a compatible SCell deactivation medium access control (MAC) control element or a dedicated request response message conveying an acknowledgment or a negative acknowledgment.

In a fourth additional aspect, alone or in combination with one or more of the first through third aspects, the first message includes the request for the state change, a confirmation message is not received within a configured time window, and the UE is configured to perform a default behavior, the default behavior including at least one of keeping the SCell active, deactivating the SCell, or performing a compatible timer-based behavior.

In a fifth additional aspect, alone or in combination with one or more of the first through fourth aspects, the first message includes an indication of the occurrence of the state change.

In a sixth additional aspect, alone or in combination with one or more of the first through fifth aspects, the event is associated with a timer expiration, wherein the timer is an sCellDeactivationTimer.

In a seventh additional aspect, alone or in combination with one or more of the first through sixth aspects, the event is associated with a buffer status.

In an eighth additional aspect, alone or in combination with one or more of the first through seventh aspects, the buffer status includes an actual buffer status or a predicted buffer status.

In a ninth additional aspect, alone or in combination with one or more of the first through eighth aspects, the event is associated with a traffic condition.

In a tenth additional aspect, alone or in combination with one or more of the first through ninth aspects, the traffic condition includes a predicted downlink traffic.

In an eleventh additional aspect, alone or in combination with one or more of the first through tenth aspects, the predicted downlink traffic is based on an application layer input.

In a twelfth additional aspect, alone or in combination with one or more of the first through eleventh aspects, the event is associated with a channel quality condition.

In a thirteenth additional aspect, alone or in combination with one or more of the first through twelfth aspects, the channel quality condition includes a channel quality measurement or a channel quality prediction.

In a fourteenth additional aspect, alone or in combination with one or more of the first through thirteenth aspects, the channel quality condition includes at least one of a layer-1 reference signal received power condition, a signal-to-interference-and-noise ratio condition, or a channel quality indicator condition.

In a fifteenth additional aspect, alone or in combination with one or more of the first through fourteenth aspects, the channel quality condition is a UE condition or a received condition.

In a sixteenth additional aspect, alone or in combination with one or more of the first through fifteenth aspects, the channel quality condition is associated with a downlink reference signal, a synchronization signal block, or a channel state information reference signal.

In a seventeenth additional aspect, alone or in combination with one or more of the first through sixteenth aspects, the channel quality condition is configured by the UE or a network.

In an eighteenth additional aspect, alone or in combination with one or more of the first through seventeenth aspects, the event is associated with an activity type within a configured window.

In a nineteenth additional aspect, alone or in combination with one or more of the first through eighteenth aspects, the configured window includes a network configured window associated with a periodic pattern.

In a twentieth additional aspect, alone or in combination with one or more of the first through nineteenth aspects, the activity type includes at least one of a detection of a downlink control information format scheduling data, a shared channel communication on the SCell, a feedback communication on the SCell, a detection of a downlink control information format triggering aperiodic channel state information measurement or reporting, a transmission of an aperiodic channel state information report, a detection of a downlink control information format triggering aperiodic sounding reference signal transmission, or a transmission of a sounding reference signal.

In a twenty-first additional aspect, alone or in combination with one or more of the first through twentieth aspects, the activity type may include a network indicated activity type.

In a twenty-second additional aspect, alone or in combination with one or more of the first through twenty-first aspects, a threshold for the activity type within the configured window includes at least one of a time threshold, an activity count threshold, an average threshold, or a rate threshold.

In a twenty-third additional aspect, alone or in combination with one or more of the first through twenty-second aspects, the threshold is associated with a plurality of configured windows.

In a twenty-fourth additional aspect, alone or in combination with one or more of the first through twenty-third aspects, the threshold is a network indicated threshold.

In a twenty-fifth additional aspect, alone or in combination with one or more of the first through twenty-fourth aspects, the threshold is configured on a per activity type basis.

In a twenty-sixth additional aspect, alone or in combination with one or more of the first through twenty-fifth aspects, the event is associated with a power headroom or energy headroom of the UE.

In a twenty-seventh additional aspect, alone or in combination with one or more of the first through twenty-sixth aspects, the event is associated with a grant prediction.

In a twenty-eighth additional aspect, alone or in combination with one or more of the first through twenty-seventh aspects, the grant prediction includes a prediction relating to at least one of a quantity of grants, a data rate of a grant, or a size of a grant.

In a twenty-ninth additional aspect, alone or in combination with one or more of the first through twenty-eighth aspects, the event is a combination of a plurality of events.

In a thirtieth additional aspect, alone or in combination with one or more of the first through twenty-ninth aspects, process 600 includes receiving configuration information associated with configuring the event, wherein the event is configured on a per SCell basis or a cross-SCell basis.

In a thirty-first additional aspect, alone or in combination with one or more of the first through thirtieth aspects, process 600 includes receiving a state change command from a network entity, wherein the state change command is associated with triggering one or more subsequent communications to complete the state change, and wherein transmitting the first message comprises transmitting the first message before a completion of the state change.

In a thirty-second additional aspect, alone or in combination with one or more of the first through thirty-first aspects, the first message includes configuration information, wherein the configuration information includes at least one of an indication of a set of SCells to which the first message is applicable, an indication of a quantity of SCells to which the first message is applicable, an indication of a type of the event, or an indication of a start time for the state change to occur.

In a thirty-third additional aspect, alone or in combination with one or more of the first through thirty-second aspects, the first message is conveyed via at least one of an uplink control information message, an uplink physical uplink shared channel message, a MAC-CE message, a UE assistance information message, or a radio resource control message.

In a thirty-fourth additional aspect, alone or in combination with one or more of the first through thirty-third aspects, process 600 includes receiving signaling enabling or disabling event-based SCell deactivation.

In a thirty-fifth additional aspect, alone or in combination with one or more of the first through thirty-fourth aspects, the signaling includes radio resource control signaling or MAC-CE signaling.

In a thirty-sixth additional aspect, alone or in combination with one or more of the first through thirty-fifth aspects, the signaling is for one or more SCells of a plurality of SCells.

In a thirty-seventh additional aspect, alone or in combination with one or more of the first through thirty-sixth aspects, process 600 includes transmitting signaling indicating support for event-based SCell deactivation.

In a thirty-eighth additional aspect, alone or in combination with one or more of the first through thirty-seventh aspects, process 600 includes transmitting signaling indicating support for one or more event-types or event parameters for event-based SCell deactivation.

In a thirty-ninth additional aspect, alone or in combination with one or more of the first through thirty-eighth aspects, the first message includes an SCell activation message or an SCell addition message.

In a fortieth additional aspect, alone or in combination with one or more of the first through thirty-ninth aspects, the first message includes the request for the state change, and the second message includes a confirmation of the request for the state change.

In a forty-first additional aspect, alone or in combination with one or more of the first through fortieth aspects, the confirmation is a compatible SCell deactivation MAC-CE or a dedicated request response message conveying an acknowledgment or a negative acknowledgment.

In a forty-second additional aspect, alone or in combination with one or more of the first through forty-first aspects, the first message includes the request for the state change, a confirmation message is not received within a configured time window, and the UE is configured to perform a default behavior, the default behavior including at least one of keeping the SCell deactivated, activating the SCell, or performing a compatible timer-based behavior.

In a forty-third additional aspect, alone or in combination with one or more of the first through forty-second aspects, the first message includes an indication of the occurrence of the state change.

In a forty-fourth additional aspect, alone or in combination with one or more of the first through forty-third aspects, the event is associated with a buffer status.

In a forty-fifth additional aspect, alone or in combination with one or more of the first through forty-fourth aspects, the buffer status includes an actual buffer status or a predicted buffer status.

In a forty-sixth additional aspect, alone or in combination with one or more of the first through forty-fifth aspects, the event is associated with a traffic condition.

In a forty-seventh additional aspect, alone or in combination with one or more of the first through forty-sixth aspects, the traffic condition includes a predicted downlink traffic.

In a forty-eighth additional aspect, alone or in combination with one or more of the first through forty-seventh aspects, the predicted downlink traffic is based on an application layer input.

In a forty-ninth additional aspect, alone or in combination with one or more of the first through forty-eighth aspects, the event is associated with a channel quality condition.

In a fiftieth additional aspect, alone or in combination with one or more of the first through forty-ninth aspects, the channel quality condition includes a channel quality measurement or a channel quality prediction.

In a fifty-first additional aspect, alone or in combination with one or more of the first through fiftieth aspects, the channel quality condition includes at least one of a layer-1 reference signal received power condition, a signal-to-interference-and-noise ratio condition, or a channel quality indicator condition.

In a fifty-second additional aspect, alone or in combination with one or more of the first through fifty-first aspects, the channel quality condition is a UE condition or a received condition.

In a fifty-third additional aspect, alone or in combination with one or more of the first through fifty-second aspects, the channel quality condition is associated with a downlink reference signal, a synchronization signal block, or a channel state information reference signal.

In a fifty-fourth additional aspect, alone or in combination with one or more of the first through fifty-third aspects, the channel quality condition is configured by the UE or a network.

In a fifty-fifth additional aspect, alone or in combination with one or more of the first through fifty-fourth aspects, the first message includes configuration information, wherein the configuration information includes at least one of an indication of a set of SCells to which the first message is applicable, an indication of a quantity of SCells to which the first message is applicable, an indication of a type of the event, or an indication of a start time for the state change to occur.

In a fifty-sixth additional aspect, alone or in combination with one or more of the first through fifty-fifth aspects, the state change is an SCell addition, and the UE is configured to add the SCell to a list of radio resource control configured SCells.

In a fifty-seventh additional aspect, alone or in combination with one or more of the first through fifty-sixth aspects, the state change is an SCell activation, and the SCell is activated using a MAC layer entity.

In a fifty-eighth additional aspect, alone or in combination with one or more of the first through fifty-seventh aspects, process 600 includes receiving configuration information associated with conveying a request for information identifying one or more SCells that can be activated.

In a fifty-ninth additional aspect, alone or in combination with one or more of the first through fifty-eighth aspects, process 600 includes receiving configuration information associated with configuring one or more metrics relating to performing an SCell activation.

In a sixtieth additional aspect, alone or in combination with one or more of the first through fifty-ninth aspects, the first message is conveyed via at least one of an uplink control information message, an uplink physical uplink shared channel message, a MAC-CE message, a UE assistance information message, or a radio resource control message.

In a sixty-first additional aspect, alone or in combination with one or more of the first through sixtieth aspects, process 600 includes receiving signaling enabling or disabling event-based SCell deactivation.

In a sixty-second additional aspect, alone or in combination with one or more of the first through sixty-first aspects, the signaling includes radio resource control signaling or MAC-CE signaling.

In a sixty-third additional aspect, alone or in combination with one or more of the first through sixty-second aspects, the signaling is for one or more SCells of a plurality of SCells.

In a sixty-fourth additional aspect, alone or in combination with one or more of the first through sixty-third aspects, process 600 includes transmitting signaling indicating support for event-based SCell deactivation.

In a sixty-fifth additional aspect, alone or in combination with one or more of the first through sixty-fourth aspects, process 600 includes transmitting signaling indicating support for one or more event-types or event parameters for event-based SCell deactivation.

In a sixty-sixth additional aspect, alone or in combination with one or more of the first through sixty-fifth aspects, process 600 includes receiving configuration information conveying an indicator that the UE-initiated state change is enabled or disabled, wherein the indicator is a per-SCell indicator or a multi-SCell indicator, and wherein transmitting the first message comprises transmitting the first message in accordance with the configuration information.

In a sixty-seventh additional aspect, alone or in combination with one or more of the first through sixty-sixth aspects, process 600 includes transmitting a UE capability message associated with indicating a capability for the UE-initiated state change, and receiving the configuration information comprises receiving the configuration information as a response to the UE capability message.

In a sixty-eighth additional aspect, alone or in combination with one or more of the first through sixty-seventh aspects, the state change includes a change to or from an SCell lightly-activated state.

In a sixty-ninth additional aspect, alone or in combination with one or more of the first through sixty-eighth aspects, the change to or from the SCell lightly-activated state is based on a compatible SCell activation or deactivation medium access control message.

In a seventieth additional aspect, alone or in combination with one or more of the first through sixty-ninth aspects, the change to or from the SCell lightly-activated state is based on a dedicated MAC-CE or downlink control information message.

In a seventy-first additional aspect, alone or in combination with one or more of the first through seventieth aspects, the change to or from the SCell lightly-activated state is based on the event.

In a seventy-second additional aspect, alone or in combination with one or more of the first through seventy-first aspects, the change is based on an event or a received signal.

In a seventy-third additional aspect, alone or in combination with one or more of the first through seventy-second aspects, the SCell lightly-activated state includes a dormant cell state with a first subset of cell operations activated and a second subset of cell operations deactivated, wherein the first subset of cell operations includes at least one of channel state information reporting, beam management, resource tracking, automatic gain control, downlink control channel monitoring, or sequence-based downlink control reception, and wherein the second subset of cell operations includes at least one of downlink control channel monitoring, downlink shared channel reception, uplink shared channel transmission, uplink control channel transmission, or sounding reference signal transmission.

In a seventy-fourth additional aspect, alone or in combination with one or more of the first through seventy-third aspects, the SCell lightly-activated state includes a deactivation timer value change relative to an activated state.

In a seventy-fifth additional aspect, alone or in combination with one or more of the first through seventy-fourth aspects, the SCell lightly-activated state includes a power saving mode.

In a seventy-sixth additional aspect, alone or in combination with one or more of the first through seventy-fifth aspects, a periodicity of the power saving mode is based on a received indication.

In a seventy-seventh additional aspect, alone or in combination with one or more of the first through seventy-sixth aspects, the received indication is conveyed via radio resource control signaling or MAC-CE signaling.

In a seventy-eighth additional aspect, alone or in combination with one or more of the first through seventy-seventh aspects, a subset of operations that are enabled or disabled during a subset of periods associated with the power saving mode is based on a static specification or a received configuration.

In a seventy-ninth additional aspect, alone or in combination with one or more of the first through seventy-eighth aspects, the first message is conveyed via at least one of a dedicated MAC-CE format message, or a dedicated downlink control information format message.

In an eightieth additional aspect, alone or in combination with one or more of the first through seventy-ninth aspects, the SCell lightly-activated state includes a set of monitoring restrictions, such that the UE is configured to monitor physical downlink control channel or sequence-based downlink control on the SCell.

In an eighty-first additional aspect, alone or in combination with one or more of the first through eightieth aspects, the UE is configured to use a low-power reference signal, in connection with the SCell lightly-activated state, for one or more measurements associated with a transition to an activated state.

In an eighty-second additional aspect, alone or in combination with one or more of the first through eighty-first aspects, the one or more measurements includes a reference signal received power report measurement or a channel state information report measurement.

In an eighty-third additional aspect, alone or in combination with one or more of the first through eighty-second aspects, the UE is configured to transmit an acknowledgment message in connection with a transition away from the SCell lightly-activated state.

In an eighty-fourth additional aspect, alone or in combination with one or more of the first through eighty-third aspects, the acknowledgment message is transmitted on a physical uplink control channel or physical uplink shared channel of the SCell using a low-power transmitter or a configured component carrier.

In an eighty-fifth additional aspect, alone or in combination with one or more of the first through eighty-fourth aspects, the transition away from the SCell lightly-activated state is configured to occur a configured quantity of symbols after a received indication or a detected condition.

In an eighty-sixth additional aspect, alone or in combination with one or more of the first through eighty-fifth aspects, the configured quantity of symbols is based on at least one of a UE capability, a UE configuration, a signaled quantity, or a target state for the transition away from the SCell lightly-activated state.

In an eighty-seventh additional aspect, alone or in combination with one or more of the first through eighty-sixth aspects, the first message is associated with indicating configuration information associated with detecting the event.

In an eighty-eighth additional aspect, alone or in combination with one or more of the first through eighty-seventh aspects, the event is associated with a timer expiration, wherein the timer is an sCellDeactivationTimer.

In an eighty-ninth additional aspect, alone or in combination with one or more of the first through eighty-eighth aspects, the event is associated with a buffer status.

In a ninetieth additional aspect, alone or in combination with one or more of the first through eighty-ninth aspects, the buffer status includes an actual buffer status or a predicted buffer status.

In a ninety-first additional aspect, alone or in combination with one or more of the first through ninetieth aspects, the event is associated with a traffic condition.

In a ninety-second additional aspect, alone or in combination with one or more of the first through ninety-first aspects, the traffic condition includes a predicted downlink traffic or an actual downlink traffic.

In a ninety-third additional aspect, alone or in combination with one or more of the first through ninety-second aspects, the predicted downlink traffic or the actual downlink traffic is based on an application layer input.

In a ninety-fourth additional aspect, alone or in combination with one or more of the first through ninety-third aspects, the traffic condition is based on at least one of a reference signal received power metric, a signal-to-interference-and-noise ratio metric, or a channel quality indicator metric.

In a ninety-fifth additional aspect, alone or in combination with one or more of the first through ninety-fourth aspects, the event is associated with an activity type within a configured window.

In a ninety-sixth additional aspect, alone or in combination with one or more of the first through ninety-fifth aspects, one or more parameters of the event are configured for the SCell lightly-activated state.

In a ninety-seventh additional aspect, alone or in combination with one or more of the first through ninety-sixth aspects, the configured window includes a network configured window associated with a periodic pattern.

In a ninety-eighth additional aspect, alone or in combination with one or more of the first through ninety-seventh aspects, the activity type includes at least one of a detection of a downlink control information format scheduling data, a shared channel communication on the SCell, a feedback communication on the SCell, a detection of a downlink control information format triggering aperiodic channel state information measurement or reporting, a transmission of an aperiodic channel state information report, a detection of a downlink control information format triggering aperiodic sounding reference signal transmission, or a transmission of a sounding reference signal.

In a ninety-ninth additional aspect, alone or in combination with one or more of the first through ninety-eighth aspects, the activity type may include a network indicated activity type.

In a one hundredth additional aspect, alone or in combination with one or more of the first through ninety-ninth aspects, a threshold for the activity type within the configured window includes at least one of a time threshold, an activity count threshold, an average threshold, or a rate threshold.

In a one hundred and first additional aspect, alone or in combination with one or more of the first through one hundredth aspects, the threshold is associated with a plurality of configured windows.

In a one hundred and second additional aspect, alone or in combination with one or more of the first through one hundred and first aspects, the threshold is a network indicated threshold.

In a one hundred and third additional aspect, alone or in combination with one or more of the first through one hundred and second aspects, the threshold is configured on a per activity type basis.

In a one hundred and fourth additional aspect, alone or in combination with one or more of the first through one hundred and third aspects, the event is a combination of a plurality of events.

In a one hundred and fifth additional aspect, alone or in combination with one or more of the first through one hundred and fourth aspects, process 600 includes receiving signaling enabling or disabling usage of the SCell lightly-activated state.

In a one hundred and sixth additional aspect, alone or in combination with one or more of the first through one hundred and fifth aspects, the signaling includes radio resource control signaling or MAC-CE signaling.

In a one hundred and seventh additional aspect, alone or in combination with one or more of the first through one hundred and sixth aspects, the signaling is for one or more SCells of a plurality of SCells.

In a one hundred and eighth additional aspect, alone or in combination with one or more of the first through one hundred and seventh aspects, the signaling includes configuration information associated with configuring a type of the SCell lightly-activated state, a transition parameter associated with a transition to or from the SCell lightly-activated state, or an event associated with the transition to or from the SCell lightly-activated state.

In a one hundred and ninth additional aspect, alone or in combination with one or more of the first through one hundred and eighth aspects, process 600 includes transmitting signaling indicating support for the SCell lightly-activated state.

In a one hundred and tenth additional aspect, alone or in combination with one or more of the first through one hundred and ninth aspects, process 600 includes transmitting signaling indicating support for one or more event-types, event parameters, or transition parameters for the SCell lightly-activated state.

In a one hundred and eleventh additional aspect, alone or in combination with one or more of the first through one hundred and tenth aspects, configuration information for the UE-initiated state change includes at least one of an indication of the event, a parameter for the event, a state transition to associate with the event, a transition time for the event.

In a one hundred and twelfth additional aspect, alone or in combination with one or more of the first through one hundred and eleventh aspects, the configuration information is on a per state change type basis, such that the configuration information includes a first configuration of one or more events or one or more parameters for a transition to the SCell lightly-activated state and a second configuration of one or more events or one or more parameters for a transition away from the SCell lightly-activated state.

In a one hundred and thirteenth additional aspect, alone or in combination with one or more of the first through one hundred and twelfth aspects, the UE is configured to signal the transition to or away from the SCell lightly-activated state.

In a one hundred and fourteenth additional aspect, alone or in combination with one or more of the first through one hundred and thirteenth aspects, a transition time to or away from the SCell lightly activated state is based on a UE capability or a received indication.

In a one hundred and fifteenth additional aspect, alone or in combination with one or more of the first through one hundred and fourteenth aspects, the transition time is on a per state change type basis.

In a one hundred and sixteenth additional aspect, alone or in combination with one or more of the first through one hundred and fifteenth aspects, process 600 includes transmitting capability information indicating a capability associated with the SCell lightly-activated state, wherein the capability includes information identifying at least one of a type of the SCell lightly-activated state, a transition associated with the SCell lightly-activated state, or the event.

In a one hundred and seventeenth additional aspect, alone or in combination with one or more of the first through one hundred and sixteenth aspects, an event is configured with a plurality of values corresponding to a plurality of possible state changes.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a flowchart illustrating an example process 700 performed, for example, at a network entity or an apparatus of a network entity that supports SCell state change messaging. Example process 700 is an example where the apparatus or the network entity (for example, network node 110) performs operations associated with SCell state change messaging.

As shown in FIG. 7, in some aspects, process 700 may include receiving a first message that indicates a request for an occurrence of a UE-initiated state change associated with an SCell in accordance with an occurrence of an event (block 710). For example, the network entity (such as by using reception component 902, depicted in FIG. 9) may wirelessly receive, from a UE, a first message that indicates a request for an occurrence of a UE-initiated state change associated with a SCell in accordance with an occurrence of an event, as described above.

As further shown in FIG. 7, in some aspects, process 700 may include transmitting, from the network entity and responsive to the request, a second message that indicates a state change associated with the SCell (block 720). For example, the network entity (such as by using transmission component 904, depicted in FIG. 9) may wirelessly transmit, from the network entity and responsive to the request, a second message that indicates a state change associated with the SCell, as described above.

Process 700 may include additional aspects, such as any single aspect or any combination of aspects described below or in connection with one or more other processes described elsewhere herein.

In a first additional aspect, the first message includes an SCell deactivation message or an SCell removal message.

In a second additional aspect, alone or in combination with the first aspect, the first message includes the request for the state change, and the second message includes a confirmation of the request for the state change.

In a third additional aspect, alone or in combination with one or more of the first and second aspects, the confirmation is a compatible SCell deactivation MAC-CE or a dedicated request response message conveying an acknowledgment or a negative acknowledgment.

In a fourth additional aspect, alone or in combination with one or more of the first through third aspects, the first message includes the request for the state change, a confirmation message is not received within a configured time window, and the UE is configured to perform a default behavior, the default behavior including at least one of keeping the SCell active, deactivating the SCell, or performing a compatible timer-based behavior.

In a fifth additional aspect, alone or in combination with one or more of the first through fourth aspects, the first message includes an indication of the occurrence of the state change.

In a sixth additional aspect, alone or in combination with one or more of the first through fifth aspects, the event is associated with a timer expiration, wherein the timer is an sCellDeactivationTimer.

In a seventh additional aspect, alone or in combination with one or more of the first through sixth aspects, the event is associated with a buffer status.

In an eighth additional aspect, alone or in combination with one or more of the first through seventh aspects, the buffer status includes an actual buffer status or a predicted buffer status.

In a ninth additional aspect, alone or in combination with one or more of the first through eighth aspects, the event is associated with a traffic condition.

In a tenth additional aspect, alone or in combination with one or more of the first through ninth aspects, the traffic condition includes a predicted downlink traffic.

In an eleventh additional aspect, alone or in combination with one or more of the first through tenth aspects, the predicted downlink traffic is based on an application layer input.

In a twelfth additional aspect, alone or in combination with one or more of the first through eleventh aspects, the event is associated with a channel quality condition.

In a thirteenth additional aspect, alone or in combination with one or more of the first through twelfth aspects, the channel quality condition includes a channel quality measurement or a channel quality prediction.

In a fourteenth additional aspect, alone or in combination with one or more of the first through thirteenth aspects, the channel quality condition includes at least one of a layer-1 reference signal received power condition, a signal-to-interference-and-noise ratio condition, or a channel quality indicator condition.

In a fifteenth additional aspect, alone or in combination with one or more of the first through fourteenth aspects, the channel quality condition is a UE condition or a received condition.

In a sixteenth additional aspect, alone or in combination with one or more of the first through fifteenth aspects, the channel quality condition is associated with a downlink reference signal, a synchronization signal block, or a channel state information reference signal.

In a seventeenth additional aspect, alone or in combination with one or more of the first through sixteenth aspects, the channel quality condition is configured by the UE or a network.

In an eighteenth additional aspect, alone or in combination with one or more of the first through seventeenth aspects, the event is associated with an activity type within a configured window.

In a nineteenth additional aspect, alone or in combination with one or more of the first through eighteenth aspects, the configured window includes a network configured window associated with a periodic pattern.

In a twentieth additional aspect, alone or in combination with one or more of the first through nineteenth aspects, the activity type includes at least one of a detection of a downlink control information format scheduling data, a shared channel communication on the SCell, a feedback communication on the SCell, a detection of a downlink control information format triggering aperiodic channel state information measurement or reporting, a transmission of an aperiodic channel state information report, a detection of a downlink control information format triggering aperiodic sounding reference signal transmission, or a transmission of a sounding reference signal.

In a twenty-first additional aspect, alone or in combination with one or more of the first through twentieth aspects, the activity type may include a network indicated activity type.

In a twenty-second additional aspect, alone or in combination with one or more of the first through twenty-first aspects, a threshold for the activity type within the configured window includes at least one of a time threshold, an activity count threshold, an average threshold, or a rate threshold.

In a twenty-third additional aspect, alone or in combination with one or more of the first through twenty-second aspects, the threshold is associated with a plurality of configured windows.

In a twenty-fourth additional aspect, alone or in combination with one or more of the first through twenty-third aspects, the threshold is a network indicated threshold.

In a twenty-fifth additional aspect, alone or in combination with one or more of the first through twenty-fourth aspects, the threshold is configured on a per activity type basis.

In a twenty-sixth additional aspect, alone or in combination with one or more of the first through twenty-fifth aspects, the event is associated with a power headroom or energy headroom of the UE.

In a twenty-seventh additional aspect, alone or in combination with one or more of the first through twenty-sixth aspects, the event is associated with a grant prediction.

In a twenty-eighth additional aspect, alone or in combination with one or more of the first through twenty-seventh aspects, the grant prediction includes a prediction relating to at least one of a quantity of grants, a data rate of a grant, or a size of a grant.

In a twenty-ninth additional aspect, alone or in combination with one or more of the first through twenty-eighth aspects, the event is a combination of a plurality of events.

In a thirtieth additional aspect, alone or in combination with one or more of the first through twenty-ninth aspects, process 700 includes transmitting configuration information associated with configuring the event, wherein the event is configured on a per SCell basis or a cross-SCell basis.

In a thirty-first additional aspect, alone or in combination with one or more of the first through thirtieth aspects, process 700 includes transmitting a state change command, wherein the state change command is associated with triggering one or more subsequent communications to complete the state change, and wherein receiving the first message comprises receiving the first message before a completion of the state change.

In a thirty-second additional aspect, alone or in combination with one or more of the first through thirty-first aspects, the first message includes configuration information, wherein the configuration information includes at least one of an indication of a set of SCells to which the first message is applicable, an indication of a quantity of SCells to which the first message is applicable, an indication of a type of the event, or an indication of a start time for the state change to occur.

In a thirty-third additional aspect, alone or in combination with one or more of the first through thirty-second aspects, the first message is conveyed via at least one of an uplink control information message, an uplink physical uplink shared channel message, a MAC-CE message, a UE assistance information message, or a radio resource control message.

In a thirty-fourth additional aspect, alone or in combination with one or more of the first through thirty-third aspects, process 700 includes transmitting signaling enabling or disabling event-based SCell deactivation.

In a thirty-fifth additional aspect, alone or in combination with one or more of the first through thirty-fourth aspects, the signaling includes radio resource control signaling or MAC-CE signaling.

In a thirty-sixth additional aspect, alone or in combination with one or more of the first through thirty-fifth aspects, the signaling is for one or more SCells of a plurality of SCells.

In a thirty-seventh additional aspect, alone or in combination with one or more of the first through thirty-sixth aspects, process 700 includes receiving signaling indicating support for event-based SCell deactivation.

In a thirty-eighth additional aspect, alone or in combination with one or more of the first through thirty-seventh aspects, process 700 includes receiving signaling indicating support for one or more event-types or event parameters for event-based SCell deactivation.

In a thirty-ninth additional aspect, alone or in combination with one or more of the first through thirty-eighth aspects, the first message includes an SCell activation message or an SCell addition message.

In a fortieth additional aspect, alone or in combination with one or more of the first through thirty-ninth aspects, the first message includes the request for the state change, and the second message includes a confirmation of the request for the state change.

In a forty-first additional aspect, alone or in combination with one or more of the first through fortieth aspects, the confirmation is a compatible SCell deactivation medium access control (MAC) control element or a dedicated request response message conveying an acknowledgment or a negative acknowledgment.

In a forty-second additional aspect, alone or in combination with one or more of the first through forty-first aspects, the first message includes the request for the state change, wherein a confirmation message is not transmitted within a configured time window, and the UE is configured to perform a default behavior, the default behavior including at least one of keeping the SCell deactivated, activating the SCell, or performing a compatible timer-based behavior.

In a forty-third additional aspect, alone or in combination with one or more of the first through forty-second aspects, the first message includes an indication of the occurrence of the state change.

In a forty-fourth additional aspect, alone or in combination with one or more of the first through forty-third aspects, the event is associated with a buffer status.

In a forty-fifth additional aspect, alone or in combination with one or more of the first through forty-fourth aspects, the buffer status includes an actual buffer status or a predicted buffer status.

In a forty-sixth additional aspect, alone or in combination with one or more of the first through forty-fifth aspects, the event is associated with a traffic condition.

In a forty-seventh additional aspect, alone or in combination with one or more of the first through forty-sixth aspects, the traffic condition includes a predicted downlink traffic.

In a forty-eighth additional aspect, alone or in combination with one or more of the first through forty-seventh aspects, the predicted downlink traffic is based on an application layer input.

In a forty-ninth additional aspect, alone or in combination with one or more of the first through forty-eighth aspects, the event is associated with a channel quality condition.

In a fiftieth additional aspect, alone or in combination with one or more of the first through forty-ninth aspects, the channel quality condition includes a channel quality measurement or a channel quality prediction.

In a fifty-first additional aspect, alone or in combination with one or more of the first through fiftieth aspects, the channel quality condition includes at least one of a layer-1 reference signal received power condition, a signal-to-interference-and-noise ratio condition, or a channel quality indicator condition.

In a fifty-second additional aspect, alone or in combination with one or more of the first through fifty-first aspects, the channel quality condition is a UE condition or a received condition.

In a fifty-third additional aspect, alone or in combination with one or more of the first through fifty-second aspects, the channel quality condition is associated with a downlink reference signal, a synchronization signal block, or a channel state information reference signal.

In a fifty-fourth additional aspect, alone or in combination with one or more of the first through fifty-third aspects, the channel quality condition is configured by the UE or a network.

In a fifty-fifth additional aspect, alone or in combination with one or more of the first through fifty-fourth aspects, the first message includes configuration information, wherein the configuration information includes at least one of an indication of a set of SCells to which the first message is applicable, an indication of a quantity of SCells to which the first message is applicable, an indication of a type of the event, or an indication of a start time for the state change to occur.

In a fifty-sixth additional aspect, alone or in combination with one or more of the first through fifty-fifth aspects, the state change is an SCell addition, and the UE is configured to add the SCell to a list of radio resource control configured SCells.

In a fifty-seventh additional aspect, alone or in combination with one or more of the first through fifty-sixth aspects, the state change is an SCell activation, and the SCell is activated using a MAC layer entity.

In a fifty-eighth additional aspect, alone or in combination with one or more of the first through fifty-seventh aspects, process 700 includes transmitting configuration information associated with conveying a request for information identifying one or more SCells that can be activated.

In a fifty-ninth additional aspect, alone or in combination with one or more of the first through fifty-eighth aspects, process 700 includes transmitting configuration information associated with configuring one or more metrics relating to performing an SCell activation.

In a sixtieth additional aspect, alone or in combination with one or more of the first through fifty-ninth aspects, the first message is conveyed via at least one of an uplink control information message, an uplink physical uplink shared channel message, a MAC-CE message, a UE assistance information message, or a radio resource control message.

In a sixty-first additional aspect, alone or in combination with one or more of the first through sixtieth aspects, process 700 includes transmitting signaling enabling or disabling event-based SCell deactivation.

In a sixty-second additional aspect, alone or in combination with one or more of the first through sixty-first aspects, the signaling includes radio resource control signaling or MAC-CE signaling.

In a sixty-third additional aspect, alone or in combination with one or more of the first through sixty-second aspects, the signaling is for one or more SCells of a plurality of SCells.

In a sixty-fourth additional aspect, alone or in combination with one or more of the first through sixty-third aspects, process 700 includes receiving signaling indicating support for event-based SCell deactivation.

In a sixty-fifth additional aspect, alone or in combination with one or more of the first through sixty-fourth aspects, process 700 includes receiving signaling indicating support for one or more event-types or event parameters for event-based SCell deactivation.

In a sixty-sixth additional aspect, alone or in combination with one or more of the first through sixty-fifth aspects, process 700 includes transmitting configuration information conveying an indicator that the UE-initiated state change is enabled or disabled, wherein the indicator is a per-SCell indicator or a multi-SCell indicator, and wherein receiving the first message comprises receiving the first message in accordance with the configuration information.

In a sixty-seventh additional aspect, alone or in combination with one or more of the first through sixty-sixth aspects, process 700 includes receiving a UE capability message associated with indicating a capability for the UE-initiated state change, and transmitting the configuration information comprises transmitting the configuration information as a response to the UE capability message.

In a sixty-eighth additional aspect, alone or in combination with one or more of the first through sixty-seventh aspects, the state change includes a change to or from an SCell lightly-activated state.

In a sixty-ninth additional aspect, alone or in combination with one or more of the first through sixty-eighth aspects, the change to or from the SCell lightly-activated state is based on a compatible SCell activation or deactivation medium access control message.

In a seventieth additional aspect, alone or in combination with one or more of the first through sixty-ninth aspects, the change to or from the SCell lightly-activated state is based on a dedicated MAC-CE or downlink control information message.

In a seventy-first additional aspect, alone or in combination with one or more of the first through seventieth aspects, the change to or from the SCell lightly-activated state is based on the event.

In a seventy-second additional aspect, alone or in combination with one or more of the first through seventy-first aspects, the change is based on an event or a received signal.

In a seventy-third additional aspect, alone or in combination with one or more of the first through seventy-second aspects, the SCell lightly-activated state includes a dormant cell state with a first subset of cell operations activated and a second subset of cell operations deactivated, wherein the first subset of cell operations includes at least one of channel state information reporting, beam management, resource tracking, automatic gain control, downlink control channel monitoring, or sequence-based downlink control reception, and wherein the second subset of cell operations includes at least one of downlink control channel monitoring, downlink shared channel reception, uplink shared channel transmission, uplink control channel transmission, or sounding reference signal transmission.

In a seventy-fourth additional aspect, alone or in combination with one or more of the first through seventy-third aspects, the SCell lightly-activated state includes a deactivation timer value change relative to an activated state.

In a seventy-fifth additional aspect, alone or in combination with one or more of the first through seventy-fourth aspects, the SCell lightly-activated state includes a power saving mode.

In a seventy-sixth additional aspect, alone or in combination with one or more of the first through seventy-fifth aspects, a periodicity of the power saving mode is based on a received indication.

In a seventy-seventh additional aspect, alone or in combination with one or more of the first through seventy-sixth aspects, the received indication is conveyed via radio resource control signaling or MAC-CE signaling.

In a seventy-eighth additional aspect, alone or in combination with one or more of the first through seventy-seventh aspects, a subset of operations that are enabled or disabled during a subset of periods associated with the power saving mode is based on a static specification or a received configuration.

In a seventy-ninth additional aspect, alone or in combination with one or more of the first through seventy-eighth aspects, the first message is conveyed via at least one of a dedicated MAC-CE format message, or a dedicated downlink control information format message.

In an eightieth additional aspect, alone or in combination with one or more of the first through seventy-ninth aspects, the SCell lightly-activated state includes a set of monitoring restrictions, such that the UE is configured to monitor physical downlink control channel or sequence-based downlink control on the SCell.

In an eighty-first additional aspect, alone or in combination with one or more of the first through eightieth aspects, the UE is configured to use a low-power reference signal, in connection with the SCell lightly-activated state, for one or more measurements associated with a transition to an activated state.

In an eighty-second additional aspect, alone or in combination with one or more of the first through eighty-first aspects, the one or more measurements includes a reference signal received power report measurement or a channel state information report measurement.

In an eighty-third additional aspect, alone or in combination with one or more of the first through eighty-second aspects, the UE is configured to transmit an acknowledgment message in connection with a transition away from the SCell lightly-activated state.

In an eighty-fourth additional aspect, alone or in combination with one or more of the first through eighty-third aspects, the acknowledgment message is transmitted on a physical uplink control channel or physical uplink shared channel of the SCell using a low-power transmitter or a configured component carrier.

In an eighty-fifth additional aspect, alone or in combination with one or more of the first through eighty-fourth aspects, the transition away from the SCell lightly-activated state is configured to occur a configured quantity of symbols after a received indication or a detected condition.

In an eighty-sixth additional aspect, alone or in combination with one or more of the first through eighty-fifth aspects, the configured quantity of symbols is based on at least one of a UE capability, a UE configuration, a signaled quantity, or a target state for the transition away from the SCell lightly-activated state.

In an eighty-seventh additional aspect, alone or in combination with one or more of the first through eighty-sixth aspects, the first message is associated with indicating configuration information associated with detecting the event.

In an eighty-eighth additional aspect, alone or in combination with one or more of the first through eighty-seventh aspects, the event is associated with a timer expiration, wherein the timer is an sCellDeactivationTimer.

In an eighty-ninth additional aspect, alone or in combination with one or more of the first through eighty-eighth aspects, the event is associated with a buffer status.

In a ninetieth additional aspect, alone or in combination with one or more of the first through eighty-ninth aspects, the buffer status includes an actual buffer status or a predicted buffer status.

In a ninety-first additional aspect, alone or in combination with one or more of the first through ninetieth aspects, the event is associated with a traffic condition.

In a ninety-second additional aspect, alone or in combination with one or more of the first through ninety-first aspects, the traffic condition includes a predicted downlink traffic or an actual downlink traffic.

In a ninety-third additional aspect, alone or in combination with one or more of the first through ninety-second aspects, the predicted downlink traffic or the actual downlink traffic is based on an application layer input.

In a ninety-fourth additional aspect, alone or in combination with one or more of the first through ninety-third aspects, the traffic condition is based on at least one of a reference signal received power metric, a signal-to-interference-and-noise ratio metric, or a channel quality indicator metric.

In a ninety-fifth additional aspect, alone or in combination with one or more of the first through ninety-fourth aspects, the event is associated with an activity type within a configured window.

In a ninety-sixth additional aspect, alone or in combination with one or more of the first through ninety-fifth aspects, one or more parameters of the event are configured for the SCell lightly-activated state.

In a ninety-seventh additional aspect, alone or in combination with one or more of the first through ninety-sixth aspects, the configured window includes a network configured window associated with a periodic pattern.

In a ninety-eighth additional aspect, alone or in combination with one or more of the first through ninety-seventh aspects, the activity type includes at least one of a detection of a downlink control information format scheduling data, a shared channel communication on the SCell, a feedback communication on the SCell, a detection of a downlink control information format triggering aperiodic channel state information measurement or reporting, a transmission of an aperiodic channel state information report, a detection of a downlink control information format triggering aperiodic sounding reference signal transmission, or a transmission of a sounding reference signal.

In a ninety-ninth additional aspect, alone or in combination with one or more of the first through ninety-eighth aspects, the activity type may include a network indicated activity type.

In a one hundredth additional aspect, alone or in combination with one or more of the first through ninety-ninth aspects, a threshold for the activity type within the configured window includes at least one of a time threshold, an activity count threshold, an average threshold, or a rate threshold.

In a one hundred and first additional aspect, alone or in combination with one or more of the first through one hundredth aspects, the threshold is associated with a plurality of configured windows.

In a one hundred and second additional aspect, alone or in combination with one or more of the first through one hundred and first aspects, the threshold is a network indicated threshold.

In a one hundred and third additional aspect, alone or in combination with one or more of the first through one hundred and second aspects, the threshold is configured on a per activity type basis.

In a one hundred and fourth additional aspect, alone or in combination with one or more of the first through one hundred and third aspects, the event is a combination of a plurality of events.

In a one hundred and fifth additional aspect, alone or in combination with one or more of the first through one hundred and fourth aspects, process 700 includes transmitting signaling enabling or disabling usage of the SCell lightly-activated state.

In a one hundred and sixth additional aspect, alone or in combination with one or more of the first through one hundred and fifth aspects, the signaling includes radio resource control signaling or medium access control (MAC) control element signaling.

In a one hundred and seventh additional aspect, alone or in combination with one or more of the first through one hundred and sixth aspects, the signaling is for one or more SCells of a plurality of SCells.

In a one hundred and eighth additional aspect, alone or in combination with one or more of the first through one hundred and seventh aspects, the signaling includes configuration information associated with configuring a type of the SCell lightly-activated state, a transition parameter associated with a transition to or from the SCell lightly-activated state, or an event associated with the transition to or from the SCell lightly-activated state.

In a one hundred and ninth additional aspect, alone or in combination with one or more of the first through one hundred and eighth aspects, process 700 includes receiving signaling indicating support for the SCell lightly-activated state.

In a one hundred and tenth additional aspect, alone or in combination with one or more of the first through one hundred and ninth aspects, process 700 includes receiving signaling indicating support for one or more event-types, event parameters, or transition parameters for the SCell lightly-activated state.

In a one hundred and eleventh additional aspect, alone or in combination with one or more of the first through one hundred and tenth aspects, configuration information for the UE-initiated state change includes at least one of an indication of the event, a parameter for the event, a state transition to associate with the event, a transition time for the event.

In a one hundred and twelfth additional aspect, alone or in combination with one or more of the first through one hundred and eleventh aspects, the configuration information is on a per state change type basis, such that the configuration information includes a first configuration of one or more events or one or more parameters for a transition to the SCell lightly-activated state and a second configuration of one or more events or one or more parameters for a transition away from the SCell lightly-activated state.

In a one hundred and thirteenth additional aspect, alone or in combination with one or more of the first through one hundred and twelfth aspects, the UE is configured to signal the transition to or away from the SCell lightly-activated state.

In a one hundred and fourteenth additional aspect, alone or in combination with one or more of the first through one hundred and thirteenth aspects, a transition time to or away from the SCell lightly activated state is based on a UE capability or a received indication.

In a one hundred and fifteenth additional aspect, alone or in combination with one or more of the first through one hundred and fourteenth aspects, the transition time is on a per state change type basis.

In a one hundred and sixteenth additional aspect, alone or in combination with one or more of the first through one hundred and fifteenth aspects, process 700 includes receiving capability information indicating a capability associated with the SCell lightly-activated state, wherein the capability includes information identifying at least one of a type of the SCell lightly-activated state, a transition associated with the SCell lightly-activated state, or the event.

In a one hundred and seventeenth additional aspect, alone or in combination with one or more of the first through one hundred and sixteenth aspects, an event is configured with a plurality of values corresponding to a plurality of possible state changes.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a diagram of an example apparatus 800 for wireless communication that supports SCell state change messaging. The apparatus 800 may be a UE, or a UE may include the apparatus 800. In some aspects, the apparatus 800 includes a reception component 802, a transmission component 804, and a communication manager 806, which may be in communication with one another (for example, via one or more buses). As shown, the apparatus 800 may communicate with another apparatus 808 (such as a UE 120, a network node 110, or another wireless communication device) using the reception component 802 and the transmission component 804. The communication manager 806 may be included in, or implemented via, a processing system (for example, the processing system 140). In some aspects, the communication manager 806 is the communication manager 150

In some aspects, the apparatus 800 may be configured to or operable to perform one or more operations described herein in connection with FIGS. 3-5. Additionally or alternatively, the apparatus 800 may be configured to or operable to perform one or more processes described herein, such as process 600 of FIG. 6.

The reception component 802 may receive communications, such as reference signals, control information, or data communications, from the apparatus 808. The reception component 802 may provide received communications to one or more other components of the apparatus 800, such as the communication manager 806. In some aspects, the reception component 802 may perform signal processing on the received communications, and may provide the processed signals to the one or more other components in a similar manner as described above in connection with FIG. 1. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, or data communications, to the apparatus 808. In some aspects, the communication manager 806 may generate communications and may transmit the generated communications to the transmission component 804 for transmission to the apparatus 808. In some aspects, the transmission component 804 may perform signal processing on the generated communications, and may transmit the processed signals to the apparatus 808 in a similar manner as described above in connection with FIG. 1. In some aspects, the transmission component 804 may include one or more components of the UE described above in connection with FIG. 1, such as a radio, one or more RF chains, one or more transceivers, or one or more modems, each of which may in turn be coupled with one or more antennas of the UE. In some aspects, the transmission component 804 may be co-located with the reception component 802.

The communication manager 806 may transmit or may cause the transmission component 804 to transmit, to a network entity, a first message that indicates a request for an occurrence of a UE-initiated state change associated with a secondary cell (SCell) in accordance with an occurrence of an event. The communication manager 806 may receive or may cause the reception component 802 to receive, from the network entity and responsive to the request, a second message that indicates a state change associated with the SCell. In some aspects, the communication manager 806 may perform one or more operations described elsewhere herein as being performed by one or more components of the communication manager 806.

In some aspects, the communication manager 806 includes a set of components, such as a state configuration component 810. Alternatively, the set of components may be separate and distinct from the communication manager 806. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The state configuration component 810 may configure a state for an SCell.

The transmission component 804 may transmit, to a network entity, a first message that indicates a request for an occurrence of a UE-initiated state change associated with a SCell in accordance with an occurrence of an event. The reception component 802 may receive, from the network entity and responsive to the request, a second message that indicates a state change associated with the SCell.

The reception component 802 may receive configuration information associated with configuring the event, wherein the event is configured on a per SCell basis or a cross-SCell basis. The reception component 802 may receive a state change command from a network entity, wherein the state change command is associated with triggering one or more subsequent communications to complete the state change. The reception component 802 may receive signaling enabling or disabling event-based SCell deactivation. The transmission component 804 may transmit signaling indicating support for event-based SCell deactivation.

The transmission component 804 may transmit signaling indicating support for one or more event-types or event parameters for event-based SCell deactivation. The reception component 802 may receive configuration information associated with conveying a request for information identifying one or more SCells that can be activated. The reception component 802 may receive configuration information associated with configuring one or more metrics relating to performing an SCell activation. The reception component 802 may receive signaling enabling or disabling event-based SCell deactivation. The transmission component 804 may transmit signaling indicating support for event-based SCell deactivation.

The transmission component 804 may transmit signaling indicating support for one or more event-types or event parameters for event-based SCell deactivation. The reception component 802 may receive configuration information conveying an indicator that the UE-initiated state change is enabled or disabled, wherein the indicator is a per-SCell indicator or a multi-SCell indicator. The transmission component 804 may transmit a UE capability message associated with indicating a capability for the UE-initiated state change.

The reception component 802 may receive signaling enabling or disabling usage of the SCell lightly-activated state. The transmission component 804 may transmit signaling indicating support for the SCell lightly-activated state. The transmission component 804 may transmit signaling indicating support for one or more event-types, event parameters, or transition parameters for the SCell lightly-activated state. The transmission component 804 may transmit capability information indicating a capability associated with the SCell lightly-activated state, wherein the capability includes information identifying at least one of a type of the SCell lightly-activated state, a transition associated with the SCell lightly-activated state, or the event.

The quantity and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

FIG. 9 is a diagram of an example apparatus 900 for wireless communication that supports SCell state change messaging. The apparatus 900 may be a network entity, or a network entity may include the apparatus 900. In some aspects, the apparatus 900 includes a reception component 902, a transmission component 904, and a communication manager 906, which may be in communication with one another (for example, via one or more buses). As shown, the apparatus 900 may communicate with another apparatus 908 (such as a UE 120, a network node 110, or another wireless communication device) using the reception component 902 and the transmission component 904. The communication manager 906 may be included in, or implemented via, a processing system (for example, the processing system 145). In some aspects, the communication manager 906 is the communication manager 155

In some aspects, the apparatus 900 may be configured to or operable to perform one or more operations described herein in connection with FIGS. 3-5. Additionally or alternatively, the apparatus 900 may be configured to or operable to perform one or more processes described herein, such as process 700 of FIG. 7.

The reception component 902 may receive communications, such as reference signals, control information, or data communications, from the apparatus 908. The reception component 902 may provide received communications to one or more other components of the apparatus 900, such as the communication manager 906. In some aspects, the reception component 902 may perform signal processing on the received communications, and may provide the processed signals to the one or more other components in a similar manner as described above in connection with FIG. 1. In some aspects, the reception component 902 may include one or more components of the network entity described above in connection with FIG. 1, such as a radio, one or more RF chains, one or more transceivers, or one or more modems, each of which may in turn be coupled with one or more antennas of the network entity.

The transmission component 904 may transmit communications, such as reference signals, control information, or data communications, to the apparatus 908. In some aspects, the communication manager 906 may generate communications and may transmit the generated communications to the transmission component 904 for transmission to the apparatus 908. In some aspects, the transmission component 904 may perform signal processing on the generated communications, and may transmit the processed signals to the apparatus 908 in a similar manner as described above in connection with FIG. 1. In some aspects, the transmission component 904 may include one or more components of the network entity described above in connection with FIG. 1, such as a radio, one or more RF chains, one or more transceivers, or one or more modems, each of which may in turn be coupled with one or more antennas of the network entity. In some aspects, the transmission component 904 may be co-located with the reception component 902.

The communication manager 906 may receive or may cause the reception component 902 to receive, from a UE, a first message that indicates a request for an occurrence of a UE-initiated state change associated with an SCell in accordance with an occurrence of an event. The communication manager 906 may transmit or may cause the transmission component 904 to transmit, from the network entity and responsive to the request, a second message that indicates a state change associated with the SCell. In some aspects, the communication manager 906 may perform one or more operations described elsewhere herein as being performed by one or more components of the communication manager 906.

In some aspects, the communication manager 906 includes a set of components, such as a configuration component 910. Alternatively, the set of components may be separate and distinct from the communication manager 906. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The configuration component 910 may configure one or more parameters of an event-based state change for a UE. The reception component 902 may receive, from a UE, a first message that indicates a request for an occurrence of a UE-initiated state change associated with an SCell in accordance with an occurrence of an event. The transmission component 904 may transmit, from the network entity and responsive to the request, a second message that indicates a state change associated with the SCell. The transmission component 904 may transmit configuration information associated with configuring the event, wherein the event is configured on a per SCell basis or a cross-SCell basis.

The transmission component 904 may transmit a state change command, wherein the state change command is associated with triggering one or more subsequent communications to complete the state change. The transmission component 904 may transmit signaling enabling or disabling event-based SCell deactivation. The reception component 902 may receive signaling indicating support for event-based SCell deactivation. The reception component 902 may receive signaling indicating support for one or more event-types or event parameters for event-based SCell deactivation.

The transmission component 904 may transmit configuration information associated with conveying a request for information identifying one or more SCells that can be activated. The transmission component 904 may transmit configuration information associated with configuring one or more metrics relating to performing an SCell activation. The transmission component 904 may transmit signaling enabling or disabling event-based SCell deactivation. The reception component 902 may receive signaling indicating support for event-based SCell deactivation.

The reception component 902 may receive signaling indicating support for one or more event-types or event parameters for event-based SCell deactivation. The transmission component 904 may transmit configuration information conveying an indicator that the UE-initiated state change is enabled or disabled, wherein the indicator is a per-SCell indicator or a multi-SCell indicator. The reception component 902 may receive a UE capability message associated with indicating a capability for the UE-initiated state change. The transmission component 904 may transmit signaling enabling or disabling usage of the SCell lightly-activated state.

The reception component 902 may receive signaling indicating support for the SCell lightly-activated state. The reception component 902 may receive signaling indicating support for one or more event-types, event parameters, or transition parameters for the SCell lightly-activated state. The reception component 902 may receive capability information indicating a capability associated with the SCell lightly-activated state, wherein the capability includes information identifying at least one of a type of the SCell lightly-activated state, a transition associated with the SCell lightly-activated state, or the event.

The quantity and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: transmitting, to a network entity, a first message that indicates a request for an occurrence of a UE-initiated state change associated with a secondary cell (SCell) in accordance with an occurrence of an event; and receiving, from the network entity and responsive to the request, a second message that indicates a state change associated with the SCell.

Aspect 2: The method of Aspect 1, wherein the first message includes an SCell deactivation message or an SCell removal message.

Aspect 3: The method of Aspect 2, wherein the first message includes the request for the state change, and wherein the second message includes a confirmation of the request for the state change.

Aspect 4: The method of Aspect 3, wherein the confirmation is a compatible SCell deactivation medium access control (MAC) control element or a dedicated request response message conveying an acknowledgment or a negative acknowledgment.

Aspect 5: The method of Aspect 2, wherein the first message includes the request for the state change, wherein a confirmation message is not received within a configured time window, and wherein the UE is configured to perform a default behavior, the default behavior including at least one of: keeping the SCell active, deactivating the SCell, or performing a compatible timer-based behavior.

Aspect 6: The method of Aspect 2, wherein the first message includes an indication of the occurrence of the state change.

Aspect 7: The method of Aspect 2, wherein the event is associated with a timer expiration, wherein the timer is an sCellDeactivationTimer.

Aspect 8: The method of Aspect 2, wherein the event is associated with a buffer status.

Aspect 9: The method of Aspect 8, wherein the buffer status includes an actual buffer status or a predicted buffer status.

Aspect 10: The method of Aspect 2, wherein the event is associated with a traffic condition.

Aspect 11: The method of Aspect 10, wherein the traffic condition includes a predicted downlink traffic.

Aspect 12: The method of Aspect 11, wherein the predicted downlink traffic is based on an application layer input.

Aspect 13: The method of Aspect 2, wherein the event is associated with a channel quality condition.

Aspect 14: The method of Aspect 13, wherein the channel quality condition includes a channel quality measurement or a channel quality prediction.

Aspect 15: The method of Aspect 13, wherein the channel quality condition includes at least one of a layer-1 reference signal received power condition, a signal-to-interference-and-noise ratio condition, or a channel quality indicator condition.

Aspect 16: The method of Aspect 13, wherein the channel quality condition is a UE condition or a received condition.

Aspect 17: The method of Aspect 13, wherein the channel quality condition is associated with a downlink reference signal, a synchronization signal block, or a channel state information reference signal.

Aspect 18: The method of Aspect 13, wherein the channel quality condition is configured by the UE or a network.

Aspect 19: The method of Aspect 2, wherein the event is associated with an activity type within a configured window.

Aspect 20: The method of Aspect 19, wherein the configured window includes a network configured window associated with a periodic pattern.

Aspect 21: The method of Aspect 19, wherein the activity type includes at least one of a detection of a downlink control information format scheduling data, a shared channel communication on the SCell, a feedback communication on the SCell, a detection of a downlink control information format triggering aperiodic channel state information measurement or reporting, a transmission of an aperiodic channel state information report, a detection of a downlink control information format triggering aperiodic sounding reference signal transmission, or a transmission of a sounding reference signal.

Aspect 22: The method of Aspect 19, wherein the activity type may include a network indicated activity type.

Aspect 23: The method of Aspect 19, wherein a threshold for the activity type within the configured window includes at least one of a time threshold, an activity count threshold, an average threshold, or a rate threshold.

Aspect 24: The method of Aspect 23, wherein the threshold is associated with a plurality of configured windows.

Aspect 25: The method of Aspect 23, wherein the threshold is a network indicated threshold.

Aspect 26: The method of Aspect 23, wherein the threshold is configured on a per activity type basis.

Aspect 27: The method of Aspect 2, wherein the event is associated with a power headroom or energy headroom of the UE.

Aspect 28: The method of Aspect 2, wherein the event is associated with a grant prediction.

Aspect 29: The method of Aspect 28, wherein the grant prediction includes a prediction relating to at least one of a quantity of grants, a data rate of a grant, or a size of a grant.

Aspect 30: The method of Aspect 2, wherein the event is a combination of a plurality of events.

Aspect 31: The method of Aspect 2, further comprising: receiving configuration information associated with configuring the event, wherein the event is configured on a per SCell basis or a cross-SCell basis.

Aspect 32: The method of Aspect 2, further comprising: receiving a state change command from a network entity, wherein the state change command is associated with triggering one or more subsequent communications to complete the state change; and wherein transmitting the first message comprises: transmitting the first message before a completion of the state change.

Aspect 33: The method of Aspect 2, wherein the first message includes configuration information, wherein the configuration information includes at least one of: an indication of a set of SCells to which the first message is applicable, an indication of a quantity of SCells to which the first message is applicable, an indication of a type of the event, or an indication of a start time for the state change to occur.

Aspect 34: The method of Aspect 2, wherein the first message is conveyed via at least one of: an uplink control information message, an uplink physical uplink shared channel message, a medium access control (MAC) control element message, a UE assistance information message, or a radio resource control message.

Aspect 35: The method of Aspect 2, further comprising: receiving signaling enabling or disabling event-based SCell deactivation.

Aspect 36: The method of Aspect 35, wherein the signaling includes radio resource control signaling or medium access control (MAC) control element signaling.

Aspect 37: The method of Aspect 35, wherein the signaling is for one or more SCells of a plurality of SCells.

Aspect 38: The method of Aspect 35, further comprising: transmitting signaling indicating support for event-based SCell deactivation.

Aspect 39: The method of Aspect 38, further comprising: transmitting signaling indicating support for one or more event-types or event parameters for event-based SCell deactivation.

Aspect 40: The method of any of Aspects 1-39, wherein the first message includes an SCell activation message or an SCell addition message.

Aspect 41: The method of Aspect 40, wherein the first message includes the request for the state change, and wherein the second message includes a confirmation of the request for the state change.

Aspect 42: The method of Aspect 41, wherein the confirmation is a compatible SCell deactivation medium access control (MAC) control element or a dedicated request response message conveying an acknowledgment or a negative acknowledgment.

Aspect 43: The method of Aspect 40, wherein the first message includes the request for the state change, wherein a confirmation message is not received within a configured time window, and wherein the UE is configured to perform a default behavior, the default behavior including at least one of: keeping the SCell deactivated, activating the SCell, or performing a compatible timer-based behavior.

Aspect 44: The method of Aspect 40, wherein the first message includes an indication of the occurrence of the state change.

Aspect 45: The method of Aspect 40, wherein the event is associated with a buffer status.

Aspect 46: The method of Aspect 45, wherein the buffer status includes an actual buffer status or a predicted buffer status.

Aspect 47: The method of Aspect 40, wherein the event is associated with a traffic condition.

Aspect 48: The method of Aspect 47, wherein the traffic condition includes a predicted downlink traffic.

Aspect 49: The method of Aspect 48, wherein the predicted downlink traffic is based on an application layer input.

Aspect 50: The method of Aspect 40, wherein the event is associated with a channel quality condition.

Aspect 51: The method of Aspect 50, wherein the channel quality condition includes a channel quality measurement or a channel quality prediction.

Aspect 52: The method of Aspect 50, wherein the channel quality condition includes at least one of a layer-1 reference signal received power condition, a signal-to-interference-and-noise ratio condition, or a channel quality indicator condition.

Aspect 53: The method of Aspect 50, wherein the channel quality condition is a UE condition or a received condition.

Aspect 54: The method of Aspect 50, wherein the channel quality condition is associated with a downlink reference signal, a synchronization signal block, or a channel state information reference signal.

Aspect 55: The method of Aspect 50, wherein the channel quality condition is configured by the UE or a network.

Aspect 56: The method of Aspect 40, wherein the first message includes configuration information, wherein the configuration information includes at least one of: an indication of a set of SCells to which the first message is applicable, an indication of a quantity of SCells to which the first message is applicable, an indication of a type of the event, or an indication of a start time for the state change to occur.

Aspect 57: The method of Aspect 40, wherein the state change is an SCell addition, and wherein the UE is configured to add the SCell to a list of radio resource control configured SCells.

Aspect 58: The method of Aspect 40, wherein the state change is an SCell activation, and wherein the SCell is activated using a medium access control (MAC) layer entity.

Aspect 59: The method of Aspect 40, further comprising: receiving configuration information associated with conveying a request for information identifying one or more SCells that can be activated.

Aspect 60: The method of Aspect 40, further comprising: receiving configuration information associated with configuring one or more metrics relating to performing an SCell activation.

Aspect 61: The method of Aspect 40, wherein the first message is conveyed via at least one of: an uplink control information message, an uplink physical uplink shared channel message, a medium access control (MAC) control element message, a UE assistance information message, or a radio resource control message.

Aspect 62: The method of Aspect 40, further comprising: receiving signaling enabling or disabling event-based SCell deactivation.

Aspect 63: The method of Aspect 62, wherein the signaling includes radio resource control signaling or medium access control (MAC) control element signaling.

Aspect 64: The method of Aspect 62, wherein the signaling is for one or more SCells of a plurality of SCells.

Aspect 65: The method of Aspect 62, further comprising: transmitting signaling indicating support for event-based SCell deactivation.

Aspect 66: The method of Aspect 65, further comprising: transmitting signaling indicating support for one or more event-types or event parameters for event-based SCell deactivation.

Aspect 67: The method of any of Aspects 1-66, further comprising: receiving configuration information conveying an indicator that the UE-initiated state change is enabled or disabled, wherein the indicator is a per-SCell indicator or a multi-SCell indicator, and wherein transmitting the first message comprises: transmitting the first message in accordance with the configuration information.

Aspect 68: The method of Aspect 67, further comprising: transmitting a UE capability message associated with indicating a capability for the UE-initiated state change; and wherein receiving the configuration information comprises: receiving the configuration information as a response to the UE capability message.

Aspect 69: The method of any of Aspects 1-68, wherein the state change includes a change to or from an SCell lightly-activated state.

Aspect 70: The method of Aspect 69, wherein the change to or from the SCell lightly-activated state is based on a compatible SCell activation or deactivation medium access control message.

Aspect 71: The method of Aspect 69, wherein the change to or from the SCell lightly-activated state is based on a dedicated medium access control (MAC) control element or downlink control information message.

Aspect 72: The method of Aspect 69, wherein the change to or from the SCell lightly-activated state is based on the event.

Aspect 73: The method of Aspect 72, wherein the change is based on an event or a received signal.

Aspect 74: The method of Aspect 69, wherein the SCell lightly-activated state includes a dormant cell state with a first subset of cell operations activated and a second subset of cell operations deactivated, wherein the first subset of cell operations includes at least one of: channel state information reporting, beam management, resource tracking, automatic gain control, downlink control channel monitoring, or sequence-based downlink control reception, and wherein the second subset of cell operations includes at least one of: downlink control channel monitoring, downlink shared channel reception, uplink shared channel transmission, uplink control channel transmission, or sounding reference signal transmission.

Aspect 75: The method of Aspect 69, wherein the SCell lightly-activated state includes a deactivation timer value change relative to an activated state.

Aspect 76: The method of Aspect 69, wherein the SCell lightly-activated state includes a power saving mode.

Aspect 77: The method of Aspect 76, wherein a periodicity of the power saving mode is based on a received indication.

Aspect 78: The method of Aspect 77, wherein the received indication is conveyed via radio resource control signaling or medium access control (MAC) control element signaling.

Aspect 79: The method of Aspect 78, wherein a subset of operations that are enabled or disabled during a subset of periods associated with the power saving mode is based on a static specification or a received configuration.

Aspect 80: The method of Aspect 69, wherein the first message is conveyed via at least one of: a dedicated medium access control (MAC) control element format message, or a dedicated downlink control information format message.

Aspect 81: The method of Aspect 69, wherein the SCell lightly-activated state includes a set of monitoring restrictions, such that the UE is configured to monitor physical downlink control channel or sequence-based downlink control on the SCell.

Aspect 82: The method of Aspect 81, wherein the UE is configured to use a low-power reference signal, in connection with the SCell lightly-activated state, for one or more measurements associated with a transition to an activated state.

Aspect 83: The method of Aspect 82, wherein the one or more measurements includes a reference signal received power report measurement or a channel state information report measurement.

Aspect 84: The method of Aspect 82, wherein the UE is configured to transmit an acknowledgment message in connection with a transition away from the SCell lightly-activated state.

Aspect 85: The method of Aspect 84, wherein the acknowledgment message is transmitted on a physical uplink control channel or physical uplink shared channel of the SCell using a low-power transmitter or a configured component carrier.

Aspect 86: The method of Aspect 84, wherein the transition away from the SCell lightly-activated state is configured to occur a configured quantity of symbols after a received indication or a detected condition.

Aspect 87: The method of Aspect 86, wherein the configured quantity of symbols is based on at least one of a UE capability, a UE configuration, a signaled quantity, or a target state for the transition away from the SCell lightly-activated state.

Aspect 88: The method of Aspect 69, wherein the first message is associated with indicating configuration information associated with detecting the event.

Aspect 89: The method of Aspect 69, wherein the event is associated with a timer expiration, wherein the timer is an sCellDeactivationTimer.

Aspect 90: The method of Aspect 69, wherein the event is associated with a buffer status.

Aspect 91: The method of Aspect 90, wherein the buffer status includes an actual buffer status or a predicted buffer status.

Aspect 92: The method of Aspect 69, wherein the event is associated with a traffic condition.

Aspect 93: The method of Aspect 92, wherein the traffic condition includes a predicted downlink traffic or an actual downlink traffic.

Aspect 94: The method of Aspect 93, wherein the predicted downlink traffic or the actual downlink traffic is based on an application layer input.

Aspect 95: The method of Aspect 92, wherein the traffic condition is based on at least one of a reference signal received power metric, a signal-to-interference-and-noise ratio metric, or a channel quality indicator metric.

Aspect 96: The method of Aspect 69, wherein the event is associated with an activity type within a configured window.

Aspect 97: The method of Aspect 96, wherein one or more parameters of the event are configured for the SCell lightly-activated state.

Aspect 98: The method of Aspect 96, wherein the configured window includes a network configured window associated with a periodic pattern.

Aspect 99: The method of Aspect 96, wherein the activity type includes at least one of a detection of a downlink control information format scheduling data, a shared channel communication on the SCell, a feedback communication on the SCell, a detection of a downlink control information format triggering aperiodic channel state information measurement or reporting, a transmission of an aperiodic channel state information report, a detection of a downlink control information format triggering aperiodic sounding reference signal transmission, or a transmission of a sounding reference signal.

Aspect 100: The method of Aspect 96, wherein the activity type may include a network indicated activity type.

Aspect 101: The method of Aspect 96, wherein a threshold for the activity type within the configured window includes at least one of a time threshold, an activity count threshold, an average threshold, or a rate threshold.

Aspect 102: The method of Aspect 101, wherein the threshold is associated with a plurality of configured windows.

Aspect 103: The method of Aspect 101, wherein the threshold is a network indicated threshold.

Aspect 104: The method of Aspect 101, wherein the threshold is configured on a per activity type basis.

Aspect 105: The method of Aspect 69, wherein the event is a combination of a plurality of events.

Aspect 106: The method of Aspect 69, further comprising: receiving signaling enabling or disabling usage of the SCell lightly-activated state.

Aspect 107: The method of Aspect 106, wherein the signaling includes radio resource control signaling or medium access control (MAC) control element signaling.

Aspect 108: The method of Aspect 106, wherein the signaling is for one or more SCells of a plurality of SCells.

Aspect 109: The method of Aspect 108, wherein the signaling includes configuration information associated with configuring a type of the SCell lightly-activated state, a transition parameter associated with a transition to or from the SCell lightly-activated state, or an event associated with the transition to or from the SCell lightly-activated state.

Aspect 110: The method of Aspect 69, further comprising: transmitting signaling indicating support for the SCell lightly-activated state.

Aspect 111: The method of Aspect 69, further comprising: transmitting signaling indicating support for one or more event-types, event parameters, or transition parameters for the SCell lightly-activated state.

Aspect 112: The method of Aspect 111, wherein configuration information for the UE-initiated state change includes at least one of: an indication of the event, a parameter for the event, a state transition to associate with the event, a transition time for the event.

Aspect 113: The method of Aspect 112, wherein the configuration information is on a per state change type basis, such that the configuration information includes a first configuration of one or more events or one or more parameters for a transition to the SCell lightly-activated state and a second configuration of one or more events or one or more parameters for a transition away from the SCell lightly-activated state.

Aspect 114: The method of Aspect 112, wherein the UE is configured to signal the transition to or away from the SCell lightly-activated state.

Aspect 115: The method of Aspect 112, wherein a transition time to or away from the SCell lightly activated state is based on a UE capability or a transmitted indication.

Aspect 116: The method of Aspect 112, wherein the transition time is on a per state change type basis.

Aspect 117: The method of Aspect 69, further comprising: transmitting capability information indicating a capability associated with the SCell lightly-activated state, wherein the capability includes information identifying at least one of: a type of the SCell lightly-activated state, a transition associated with the SCell lightly-activated state, or the event.

Aspect 118: The method of any of Aspects 1-117, wherein an event is configured with a plurality of values corresponding to a plurality of possible state changes.

Aspect 119: A method of wireless communication performed by a network entity, comprising: receiving, from a user equipment (UE), a first message that indicates a request for an occurrence of a UE-initiated state change associated with a secondary cell (SCell) in accordance with an occurrence of an event; and transmitting, from the network entity and responsive to the request, a second message that indicates a state change associated with the SCell.

Aspect 120: The method of Aspect 119, wherein the first message includes an SCell deactivation message or an SCell removal message.

Aspect 121: The method of Aspect 120, wherein the first message includes the request for the state change, and wherein the second message includes a confirmation of the request for the state change.

Aspect 122: The method of Aspect 121, wherein the confirmation is a compatible SCell deactivation medium access control (MAC) control element or a dedicated request response message conveying an acknowledgment or a negative acknowledgment.

Aspect 123: The method of Aspect 120, wherein the first message includes the request for the state change, wherein a confirmation message is not transmitted within a configured time window, and wherein the UE is configured to perform a default behavior, the default behavior including at least one of: keeping the SCell active, deactivating the SCell, or performing a compatible timer-based behavior.

Aspect 124: The method of Aspect 120, wherein the first message includes an indication of the occurrence of the state change.

Aspect 125: The method of Aspect 120, wherein the event is associated with a timer expiration, wherein the timer is an sCellDeactivationTimer.

Aspect 126: The method of Aspect 120, wherein the event is associated with a buffer status.

Aspect 127: The method of Aspect 126, wherein the buffer status includes an actual buffer status or a predicted buffer status.

Aspect 128: The method of Aspect 120, wherein the event is associated with a traffic condition.

Aspect 129: The method of Aspect 128, wherein the traffic condition includes a predicted downlink traffic.

Aspect 130: The method of Aspect 129, wherein the predicted downlink traffic is based on an application layer input.

Aspect 131: The method of Aspect 120, wherein the event is associated with a channel quality condition.

Aspect 132: The method of Aspect 131, wherein the channel quality condition includes a channel quality measurement or a channel quality prediction.

Aspect 133: The method of Aspect 131, wherein the channel quality condition includes at least one of a layer-1 reference signal received power condition, a signal-to-interference-and-noise ratio condition, or a channel quality indicator condition.

Aspect 134: The method of Aspect 131, wherein the channel quality condition is a UE condition or a transmitted condition.

Aspect 135: The method of Aspect 131, wherein the channel quality condition is associated with a downlink reference signal, a synchronization signal block, or a channel state information reference signal.

Aspect 136: The method of Aspect 131, wherein the channel quality condition is configured by the UE or a network.

Aspect 137: The method of Aspect 120, wherein the event is associated with an activity type within a configured window.

Aspect 138: The method of Aspect 137, wherein the configured window includes a network configured window associated with a periodic pattern.

Aspect 139: The method of Aspect 137, wherein the activity type includes at least one of a detection of a downlink control information format scheduling data, a shared channel communication on the SCell, a feedback communication on the SCell, a detection of a downlink control information format triggering aperiodic channel state information measurement or reporting, a transmission of an aperiodic channel state information report, a detection of a downlink control information format triggering aperiodic sounding reference signal transmission, or a transmission of a sounding reference signal.

Aspect 140: The method of Aspect 137, wherein the activity type may include a network indicated activity type.

Aspect 141: The method of Aspect 137, wherein a threshold for the activity type within the configured window includes at least one of a time threshold, an activity count threshold, an average threshold, or a rate threshold.

Aspect 142: The method of Aspect 141, wherein the threshold is associated with a plurality of configured windows.

Aspect 143: The method of Aspect 141, wherein the threshold is a network indicated threshold.

Aspect 144: The method of Aspect 141, wherein the threshold is configured on a per activity type basis.

Aspect 145: The method of Aspect 120, wherein the event is associated with a power headroom or energy headroom of the UE.

Aspect 146: The method of Aspect 120, wherein the event is associated with a grant prediction.

Aspect 147: The method of Aspect 146, wherein the grant prediction includes a prediction relating to at least one of a quantity of grants, a data rate of a grant, or a size of a grant.

Aspect 148: The method of Aspect 120, wherein the event is a combination of a plurality of events.

Aspect 149: The method of Aspect 120, further comprising: transmitting configuration information associated with configuring the event, wherein the event is configured on a per SCell basis or a cross-SCell basis.

Aspect 150: The method of Aspect 120, further comprising: transmitting a state change command, wherein the state change command is associated with triggering one or more subsequent communications to complete the state change; and wherein receiving the first message comprises: receiving the first message before a completion of the state change.

Aspect 151: The method of Aspect 120, wherein the first message includes configuration information, wherein the configuration information includes at least one of: an indication of a set of SCells to which the first message is applicable, an indication of a quantity of SCells to which the first message is applicable, an indication of a type of the event, or an indication of a start time for the state change to occur.

Aspect 152: The method of Aspect 120, wherein the first message is conveyed via at least one of: an uplink control information message, an uplink physical uplink shared channel message, a medium access control (MAC) control element message, a UE assistance information message, or a radio resource control message.

Aspect 153: The method of Aspect 120, further comprising: transmitting signaling enabling or disabling event-based SCell deactivation.

Aspect 154: The method of Aspect 153, wherein the signaling includes radio resource control signaling or medium access control (MAC) control element signaling.

Aspect 155: The method of Aspect 153, wherein the signaling is for one or more SCells of a plurality of SCells.

Aspect 156: The method of Aspect 153, further comprising: receiving signaling indicating support for event-based SCell deactivation.

Aspect 157: The method of Aspect 156, further comprising: receiving signaling indicating support for one or more event-types or event parameters for event-based SCell deactivation.

Aspect 158: The method of any of Aspects 119-157, wherein the first message includes an SCell activation message or an SCell addition message.

Aspect 159: The method of Aspect 158, wherein the first message includes the request for the state change, and wherein the second message includes a confirmation of the request for the state change.

Aspect 160: The method of Aspect 159, wherein the confirmation is a compatible SCell deactivation medium access control (MAC) control element or a dedicated request response message conveying an acknowledgment or a negative acknowledgment.

Aspect 161: The method of Aspect 158, wherein the first message includes the request for the state change, wherein a confirmation message is not transmitted within a configured time window, and wherein the UE is configured to perform a default behavior, the default behavior including at least one of: keeping the SCell deactivated, activating the SCell, or performing a compatible timer-based behavior.

Aspect 162: The method of Aspect 158, wherein the first message includes an indication of the occurrence of the state change.

Aspect 163: The method of Aspect 158, wherein the event is associated with a buffer status.

Aspect 164: The method of Aspect 163, wherein the buffer status includes an actual buffer status or a predicted buffer status.

Aspect 165: The method of Aspect 158, wherein the event is associated with a traffic condition.

Aspect 166: The method of Aspect 165, wherein the traffic condition includes a predicted downlink traffic.

Aspect 167: The method of Aspect 166, wherein the predicted downlink traffic is based on an application layer input.

Aspect 168: The method of Aspect 158, wherein the event is associated with a channel quality condition.

Aspect 169: The method of Aspect 168, wherein the channel quality condition includes a channel quality measurement or a channel quality prediction.

Aspect 170: The method of Aspect 168, wherein the channel quality condition includes at least one of a layer-1 reference signal received power condition, a signal-to-interference-and-noise ratio condition, or a channel quality indicator condition.

Aspect 171: The method of Aspect 168, wherein the channel quality condition is a UE condition or a transmitted condition.

Aspect 172: The method of Aspect 168, wherein the channel quality condition is associated with a downlink reference signal, a synchronization signal block, or a channel state information reference signal.

Aspect 173: The method of Aspect 168, wherein the channel quality condition is configured by the UE or a network.

Aspect 174: The method of Aspect 158, wherein the first message includes configuration information, wherein the configuration information includes at least one of: an indication of a set of SCells to which the first message is applicable, an indication of a quantity of SCells to which the first message is applicable, an indication of a type of the event, or an indication of a start time for the state change to occur.

Aspect 175: The method of Aspect 158, wherein the state change is an SCell addition, and wherein the UE is configured to add the SCell to a list of radio resource control configured SCells.

Aspect 176: The method of Aspect 158, wherein the state change is an SCell activation, and wherein the SCell is activated using a medium access control (MAC) layer entity.

Aspect 177: The method of Aspect 158, further comprising: transmitting configuration information associated with conveying a request for information identifying one or more SCells that can be activated.

Aspect 178: The method of Aspect 158, further comprising: transmitting configuration information associated with configuring one or more metrics relating to performing an SCell activation.

Aspect 179: The method of Aspect 158, wherein the first message is conveyed via at least one of: an uplink control information message, an uplink physical uplink shared channel message, a medium access control (MAC) control element message, a UE assistance information message, or a radio resource control message.

Aspect 180: The method of Aspect 158, further comprising: transmitting signaling enabling or disabling event-based SCell deactivation.

Aspect 181: The method of Aspect 180, wherein the signaling includes radio resource control signaling or medium access control (MAC) control element signaling.

Aspect 182: The method of Aspect 180, wherein the signaling is for one or more SCells of a plurality of SCells.

Aspect 183: The method of Aspect 180, further comprising: receiving signaling indicating support for event-based SCell deactivation.

Aspect 184: The method of Aspect 183, further comprising: receiving signaling indicating support for one or more event-types or event parameters for event-based SCell deactivation.

Aspect 185: The method of any of Aspects 119-184, further comprising: transmitting configuration information conveying an indicator that the UE-initiated state change is enabled or disabled, wherein the indicator is a per-SCell indicator or a multi-SCell indicator, and wherein receiving the first message comprises: receiving the first message in accordance with the configuration information.

Aspect 186: The method of Aspect 185, further comprising: receiving a UE capability message associated with indicating a capability for the UE-initiated state change; and wherein transmitting the configuration information comprises: transmitting the configuration information as a response to the UE capability message.

Aspect 187: The method of any of Aspects 119-186, wherein the state change includes a change to or from an SCell lightly-activated state.

Aspect 188: The method of Aspect 187, wherein the change to or from the SCell lightly-activated state is based on a compatible SCell activation or deactivation medium access control message.

Aspect 189: The method of Aspect 187, wherein the change to or from the SCell lightly-activated state is based on a dedicated medium access control (MAC) control element or downlink control information message.

Aspect 190: The method of Aspect 187, wherein the change to or from the SCell lightly-activated state is based on the event.

Aspect 191: The method of Aspect 190, wherein the change is based on an event or a transmitted signal.

Aspect 192: The method of Aspect 187, wherein the SCell lightly-activated state includes a dormant cell state with a first subset of cell operations activated and a second subset of cell operations deactivated, wherein the first subset of cell operations includes at least one of: channel state information reporting, beam management, resource tracking, automatic gain control, downlink control channel monitoring, or sequence-based downlink control reception, and wherein the second subset of cell operations includes at least one of: downlink control channel monitoring, downlink shared channel reception, uplink shared channel transmission, uplink control channel transmission, or sounding reference signal transmission.

Aspect 193: The method of Aspect 187, wherein the SCell lightly-activated state includes a deactivation timer value change relative to an activated state.

Aspect 194: The method of Aspect 187, wherein the SCell lightly-activated state includes a power saving mode.

Aspect 195: The method of Aspect 194, wherein a periodicity of the power saving mode is based on a transmitted indication.

Aspect 196: The method of Aspect 195, wherein the transmitted indication is conveyed via radio resource control signaling or medium access control (MAC) control element signaling.

Aspect 197: The method of Aspect 196, wherein a subset of operations that are enabled or disabled during a subset of periods associated with the power saving mode is based on a static specification or a transmitted configuration.

Aspect 198: The method of Aspect 187, wherein the first message is conveyed via at least one of: a dedicated medium access control (MAC) control element format message, or a dedicated downlink control information format message.

Aspect 199: The method of Aspect 187, wherein the SCell lightly-activated state includes a set of monitoring restrictions, such that the UE is configured to monitor physical downlink control channel or sequence-based downlink control on the SCell.

Aspect 200: The method of Aspect 199, wherein the UE is configured to use a low-power reference signal, in connection with the SCell lightly-activated state, for one or more measurements associated with a transition to an activated state.

Aspect 201: The method of Aspect 200, wherein the one or more measurements includes a reference signal received power report measurement or a channel state information report measurement.

Aspect 202: The method of Aspect 200, wherein the UE is configured to transmit an acknowledgment message in connection with a transition away from the SCell lightly-activated state.

Aspect 203: The method of Aspect 202, wherein the acknowledgment message is transmitted on a physical uplink control channel or physical uplink shared channel of the SCell using a low-power transmitter or a configured component carrier.

Aspect 204: The method of Aspect 202, wherein the transition away from the SCell lightly-activated state is configured to occur a configured quantity of symbols after a transmitted indication or a detected condition.

Aspect 205: The method of Aspect 204, wherein the configured quantity of symbols is based on at least one of a UE capability, a UE configuration, a signaled quantity, or a target state for the transition away from the SCell lightly-activated state.

Aspect 206: The method of Aspect 187, wherein the first message is associated with indicating configuration information associated with detecting the event.

Aspect 207: The method of Aspect 187, wherein the event is associated with a timer expiration, wherein the timer is an sCellDeactivationTimer.

Aspect 208: The method of Aspect 187, wherein the event is associated with a buffer status.

Aspect 209: The method of Aspect 208, wherein the buffer status includes an actual buffer status or a predicted buffer status.

Aspect 210: The method of Aspect 187, wherein the event is associated with a traffic condition.

Aspect 211: The method of Aspect 210, wherein the traffic condition includes a predicted downlink traffic or an actual downlink traffic.

Aspect 212: The method of Aspect 211, wherein the predicted downlink traffic or the actual downlink traffic is based on an application layer input.

Aspect 213: The method of Aspect 210, wherein the traffic condition is based on at least one of a reference signal received power metric, a signal-to-interference-and-noise ratio metric, or a channel quality indicator metric.

Aspect 214: The method of Aspect 187, wherein the event is associated with an activity type within a configured window.

Aspect 215: The method of Aspect 214, wherein one or more parameters of the event are configured for the SCell lightly-activated state.

Aspect 216: The method of Aspect 214, wherein the configured window includes a network configured window associated with a periodic pattern.

Aspect 217: The method of Aspect 214, wherein the activity type includes at least one of a detection of a downlink control information format scheduling data, a shared channel communication on the SCell, a feedback communication on the SCell, a detection of a downlink control information format triggering aperiodic channel state information measurement or reporting, a transmission of an aperiodic channel state information report, a detection of a downlink control information format triggering aperiodic sounding reference signal transmission, or a transmission of a sounding reference signal.

Aspect 218: The method of Aspect 214, wherein the activity type may include a network indicated activity type.

Aspect 219: The method of Aspect 214, wherein a threshold for the activity type within the configured window includes at least one of a time threshold, an activity count threshold, an average threshold, or a rate threshold.

Aspect 220: The method of Aspect 219, wherein the threshold is associated with a plurality of configured windows.

Aspect 221: The method of Aspect 219, wherein the threshold is a network indicated threshold.

Aspect 222: The method of Aspect 219, wherein the threshold is configured on a per activity type basis.

Aspect 223: The method of Aspect 187, wherein the event is a combination of a plurality of events.

Aspect 224: The method of Aspect 187, further comprising: transmitting signaling enabling or disabling usage of the SCell lightly-activated state.

Aspect 225: The method of Aspect 224, wherein the signaling includes radio resource control signaling or medium access control (MAC) control element signaling.

Aspect 226: The method of Aspect 224, wherein the signaling is for one or more SCells of a plurality of SCells.

Aspect 227: The method of Aspect 226, wherein the signaling includes configuration information associated with configuring a type of the SCell lightly-activated state, a transition parameter associated with a transition to or from the SCell lightly-activated state, or an event associated with the transition to or from the SCell lightly-activated state.

Aspect 228: The method of Aspect 187, further comprising: receiving signaling indicating support for the SCell lightly-activated state.

Aspect 229: The method of Aspect 187, further comprising: receiving signaling indicating support for one or more event-types, event parameters, or transition parameters for the SCell lightly-activated state.

Aspect 230: The method of Aspect 229, wherein configuration information for the UE-initiated state change includes at least one of: an indication of the event, a parameter for the event, a state transition to associate with the event, a transition time for the event.

Aspect 231: The method of Aspect 230, wherein the configuration information is on a per state change type basis, such that the configuration information includes a first configuration of one or more events or one or more parameters for a transition to the SCell lightly-activated state and a second configuration of one or more events or one or more parameters for a transition away from the SCell lightly-activated state.

Aspect 232: The method of Aspect 230, wherein the UE is configured to signal the transition to or away from the SCell lightly-activated state.

Aspect 233: The method of Aspect 230, wherein a transition time to or away from the SCell lightly activated state is based on a UE capability or a received indication.

Aspect 234: The method of Aspect 230, wherein the transition time is on a per state change type basis.

Aspect 235: The method of Aspect 187, further comprising: receiving capability information indicating a capability associated with the SCell lightly-activated state, wherein the capability includes information identifying at least one of: a type of the SCell lightly-activated state, a transition associated with the SCell lightly-activated state, or the event.

Aspect 236: The method of any of Aspects 119-235, wherein an event is configured with a plurality of values corresponding to a plurality of possible state changes.

Aspect 237: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-236.

Aspect 238: An apparatus for wireless communication at a device, the apparatus comprising one or more memories and one or more processors coupled to the one or more memories, the one or more processors configured to cause the device to perform the method of one or more of Aspects 1-236.

Aspect 239: An apparatus for wireless communication, the apparatus comprising at least one means for performing the method of one or more of Aspects 1-236.

Aspect 240: A non-transitory computer-readable medium storing code for wireless communication, the code comprising instructions executable by one or more processors to perform the method of one or more of Aspects 1-236.

Aspect 241: A non-transitory computer-readable medium storing a set of instructions for wireless communication, the set of instructions comprising one or more instructions that, when executed by one or more processors of a device, cause the device to perform the method of one or more of Aspects 1-236.

Aspect 242: A device for wireless communication, the device comprising a processing system that includes one or more processors and one or more memories coupled with the one or more processors, the processing system configured to cause the device to perform the method of one or more of Aspects 1-236.

Aspect 243: An apparatus for wireless communication at a device, the apparatus comprising one or more memories and one or more processors coupled to the one or more memories, the one or more processors individually or collectively configured to cause the device to perform the method of one or more of Aspects 1-236.

Aspect 244: A device comprising a processing system that includes one or more processors and one or more code-storing memories coupled with the one or more processors, the processing system configured to cause the device to perform the method of one or more of Aspects 1-236.

Aspect 245: A device comprising a processing system that includes processor circuitry and code-storing memory circuitry, the processing system configured to cause the device to perform the method of one or more of Aspects 1-236.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
one or more antennas; and
a processing system that includes processor circuitry and memory circuitry that stores code for the processor circuitry, the processing system configured to cause the UE to:
wirelessly transmit, to a network entity, a first message that indicates a request for an occurrence of a UE-initiated state change associated with a secondary cell (SCell) in accordance with an occurrence of an event; and
wirelessly receive, from the network entity and responsive to the request, a second message that indicates a state change associated with the SCell.

2. The UE of claim 1, wherein the first message includes:
an SCell deactivation message,
an SCell removal message,
an Scell activation message, or
an Scell addition message.

3. The UE of claim 2, wherein the first message includes the request for the state change, and
wherein the second message includes a confirmation of the request for the state change.

4. The UE of claim 2, wherein the first message includes the request for the state change, wherein a confirmation message is not received within a configured time window, and wherein the UE is configured to perform a default behavior, the default behavior including at least one of:
keeping the SCell active,
deactivating the SCell, or
performing a compatible timer-based behavior.

5. The UE of claim 2, wherein the first message includes an indication of the occurrence of the state change.

6. The UE of claim 2, wherein the event is associated with at least one of:
timer expiration, wherein the timer is an sCellDeactivationTimer,
a buffer status,
a traffic condition,
a channel quality condition,
an activity type within a configured window,
a power headroom or energy headroom of the UE,
a grant prediction, or
a combination thereof.

7. The UE of claim 2, wherein the processing system is configured to cause the UE to:
receive configuration information associated with configuring the event, wherein the event is configured on a per SCell basis or a cross-SCell basis.

8. The UE of claim 2, wherein the processing system is configured to cause the UE to:
receive a state change command from a network entity, wherein the state change command is associated with triggering one or more subsequent communications to complete the state change; and
wherein the processing system, to cause the UE to transmit the first message, is configured to cause the UE to:
transmit the first message before a completion of the state change.

9. The UE of claim 2, wherein the first message includes configuration information, wherein the configuration information includes at least one of:
an indication of a set of SCells to which the first message is applicable,
an indication of a quantity of SCells to which the first message is applicable,
an indication of a type of the event, or
an indication of a start time for the state change to occur.

10. The UE of claim 2, wherein the first message is conveyed via at least one of:
an uplink control information message,
an uplink physical uplink shared channel message,
a medium access control (MAC) control element message,
a UE assistance information message, or
a radio resource control message.

11. The UE of claim 2, wherein the processing system is configured to cause the UE to:
receive signaling enabling or disabling event-based SCell deactivation.

12. The UE of claim 1, wherein the processing system is configured to cause the UE to:
receive configuration information conveying an indicator that the UE-initiated state change is enabled or disabled, wherein the indicator is a per-SCell indicator or a multi-SCell indicator, and
wherein the processing system, to cause the UE to transmit the first message, is configured to cause the UE to:
transmit the first message in accordance with the configuration information.

13. The UE of claim 12, wherein the processing system is configured to cause the UE to:
transmit a UE capability message associated with indicating a capability for the UE-initiated state change; and
wherein the processing system, to cause the UE to receive the configuration information, is configured to cause the UE to:
receive the configuration information as a response to the UE capability message.

14. The UE of claim 1, wherein the state change includes a change to or from an SCell lightly-activated state.

15. The UE of claim 14, wherein the change to or from the SCell lightly-activated state is based on at least one of:
a compatible SCell activation or deactivation medium access control message,
a dedicated medium access control (MAC) control element or downlink control information message, or
the event.

16. The UE of claim 14, wherein the SCell lightly-activated state includes a dormant cell state with a first subset of cell operations activated and a second subset of cell operations deactivated,
wherein the first subset of cell operations includes at least one of:
channel state information reporting,
beam management,
resource tracking,
automatic gain control,
downlink control channel monitoring, or
sequence-based downlink control reception, and
wherein the second subset of cell operations includes at least one of:
downlink control channel monitoring,
downlink shared channel reception,
uplink shared channel transmission,
uplink control channel transmission, or
sounding reference signal transmission.

17. The UE of claim 14, wherein the SCell lightly-activated state includes at least one of:
a deactivation timer value change relative to an activated state,
a power saving mode, or
a set of monitoring restrictions, such that the UE is configured to monitor physical downlink control channel or sequence-based downlink control on the SCell.

18. The UE of claim 14, wherein the first message is associated with indicating configuration information associated with detecting the event.

19. The UE of claim 14, wherein the event is associated with at least one of:
a timer expiration, wherein the timer is an sCellDeactivationTimer,
a buffer status,
a traffic condition,
an activity type within a configured window,
a combination thereof.

20. The UE of claim 14, wherein the processing system is configured to cause the UE to:
receive signaling enabling or disabling usage of the SCell lightly-activated state.

21. The UE of claim 14, wherein the processing system is configured to cause the UE to:
transmit signaling indicating support for the SCell lightly-activated state.

22. The UE of claim 14, wherein the processing system is configured to cause the UE to:
transmit signaling indicating support for one or more event-types, event parameters, or transition parameters for the SCell lightly-activated state; and
receive configuration information associated with the signaling.

23. The UE of claim 14, wherein the processing system is configured to cause the UE to:
transmit capability information indicating a capability associated with the SCell lightly-activated state, wherein the capability includes information identifying at least one of:
a type of the SCell lightly-activated state,
a transition associated with the SCell lightly-activated state, or
the event.

24. The UE of claim 1, wherein the event is configured with a plurality of values corresponding to a plurality of possible state changes.

25. A network entity, comprising:
one or more antennas; and
a processing system that includes processor circuitry and memory circuitry that stores code for the processor circuitry, the processing system configured to cause the network entity to:
wirelessly receive, from a user equipment (UE), a first message that indicates a request for an occurrence of a UE-initiated state change associated with a secondary cell (SCell) in accordance with an occurrence of an event; and
wirelessly transmit, from the network entity and responsive to the request, a second message that indicates a state change associated with the SCell.

26. The network entity of claim 25, wherein the first message includes an SCell deactivation message or an SCell removal message.

27. The network entity of claim 26, wherein the first message includes the request for the state change, and
wherein the second message includes a confirmation of the request for the state change.

28. The network entity of claim 27, wherein the confirmation is a compatible SCell deactivation medium access control (MAC) control element or a dedicated request response message conveying an acknowledgment or a negative acknowledgment.

29. A method of wireless communication performed by a user equipment (UE), comprising:
wirelessly transmitting, to a network entity, a first message that indicates a request for an occurrence of a UE-initiated state change associated with a secondary cell (SCell) in accordance with an occurrence of an event; and
wirelessly receiving, from the network entity and responsive to the request, a second message that indicates a state change associated with the SCell.

30. A method of wireless communication performed by a network entity, comprising:
wirelessly receiving, from a user equipment (UE), a first message that indicates a request for an occurrence of a UE-initiated state change associated with a secondary cell (SCell) in accordance with an occurrence of an event; and
wirelessly transmitting, from the network entity and responsive to the request, a second message that indicates a state change associated with the SCell.
